(19) United States
(12) Patent Application Publication
(10) Pub. No.: US 2026/0283753 A1
(43) Pub. Date: Sep. 24, 2026

(54) ORTHODONTIC BRACKET ASSEMBLY AND PROCESS OF MANUFACTURING ORTHODONTIC BRACKET ASSEMBLY

(71) Applicant: Ornge Orthodontics Inc., Hicksville, NY (US)

(72) Inventors: Ammar SYED, Unionville (CA); Colin J. COREY, Carlsbad, CA (US); Edward L. MASSARO, Bryn Mawr, PA (US)

(73) Assignee: Ornge Orthodontics Inc., Hicksville, NY (US)

(21) Appl. No.: 19/471,691

(22) PCT Filed: Apr. 1, 2024
(86) PCT No.: PCT/US2024/022556

§ 371 Date: Oct. 1, 2025

Related U.S. Application Data
(60) Provisional application No. 63/493,930, filed on Apr. 3, 2023.
(60) Provisional application No. 63/493,929, filed on Apr. 3, 2023.

(51) Int. Cl. A61C 7/16; A61C 7/00; B33Y 80/00

(52) U.S. Cl. CPC A61C 7/16; A61C 7/002; B33Y 80/00

(57) ABSTRACT

An orthodontic bracket assembly includes a bracket portion and a base portion. The bracket portion includes a body including a first side and a second side. The base portion includes a first side and a second side. The second side of the base portion can include a base contour configured to contact a surface of a patient's tooth. The bracket portion can be affixed to the base portion with the first side of the bracket portion facing away from the first side of the base portion. An orthodontic prescription for the patient's tooth can be incorporated into the orthodontic bracket assembly. A process of manufacturing an orthodontic bracket assembly can include forming a base portion by an additive manufacturing process, providing a bracket portion, and affixing the bracket portion to the base portion.

### CROSS-REFERENCE TO RELATED APPLICATIONS

This application claims priority of U.S. Provisional Patent Application No. 63/493,930, filed Apr. 3, 2023, and U.S. Provisional Patent Application No. 63/493,929, filed Apr. 3, 2023, the entire content of each which is incorporated herein by reference.

### FIELD

The present field relates to orthodontic appliances and processes of manufacturing orthodontic appliances.

### BACKGROUND

Orthodontic appliances such as braces typically include brackets that are bonded to facial surfaces of a patient's teeth. A bracket typically includes a base that can be bonded to a tooth surface and an archwire slot for receiving an archwire. Ligatures can be attached to the bracket to retain an archwire in the archwire slot. The archwire can apply force to the brackets to slowly move teeth into desired positions.

Brackets can be made by injection molding processes. However, many expensive injection molds may be necessary to construct brackets covering a wide range of possible orthodontic prescriptions and tooth shapes. Additive manufacturing can also be used to construct brackets. However, brackets constructed using additive manufacturing may lack properties that are normally associated with braces. Also, constructing brackets using additive manufacturing processes can be time consuming.

### BRIEF DESCRIPTION OF THE DRAWINGS

FIG. 1 is a front perspective view of an embodiment of a bracket assembly;

FIG. 2 is top perspective view of the bracket assembly in FIG. 1;

FIG. 3 illustrates a cross-sectional view taken along line 3-3 in FIG. 2;

FIG. 4 illustrates an unassembled configuration of the bracket assembly in FIG. 1;

FIG. 5 illustrates backside view of the bracket assembly illustrated in FIG. 1;

FIGS. 6 and 7 illustrate opposite side elevational views of the bracket assembly in FIG. 1;

FIG. 8 is an occlusal side elevational view of the bracket assembly in FIG. 1;

FIG. 9 is a gingival side elevational view of the bracket assembly in FIG. 1;

FIG. 10 is a cross-sectional view of an embodiment a bracket assembly;

FIG. 11 illustrates an embodiment of a bracket assembly adjacent to a surface of a tooth to which the bracket assembly is configured to be attached;

FIG. 12 illustrates an embodiment of a series of teeth along a maxillary arch;

FIG. 13 illustrates an embodiment of a molar;

FIG. 14 illustrates an embodiment of a bracket assembly adjacent to a surface of a tooth to which the bracket assembly is configured to be attached; and

FIG. 15 illustrates a patient's dentition including embodiments of bracket assemblies disposed on surfaces of teeth.

FIG. 16 illustrates a cross-sectional view of the bracket assembly in FIG. 1;

FIG. 16A illustrates an enlarged view of a portion of the bracket assembly in FIG. 16;

FIG. 17 illustrates a backside view of the bracket assembly illustrated in FIG. 1;

FIG. 18 illustrates top perspective view of a plane resting on a facial-most surface of a first side of the body of a bracket portion of the bracket assembly in FIG. 1;

FIG. 19 illustrates a cross-sectional view of an embodiment of a bracket assembly;

FIG. 20 illustrates a cross-sectional view of an embodiment of a bracket assembly;

FIG. 21 illustrates a cross-sectional view of an embodiment of a bracket assembly;

FIG. 22 illustrates a cross-sectional view of an embodiment of a bracket assembly;

FIG. 23 illustrates a cross-sectional view of an embodiment of a bracket assembly;

FIG. 24 illustrates a cross-sectional view of the bracket assembly in FIG. 1;

FIG. 25 illustrates a cross-sectional view of an embodiment of a bracket assembly;

FIG. 26 illustrates a top plan view of the bracket assembly in FIG. 1;

FIG. 27 illustrates a top plan view of an embodiment of bracket assembly;

FIG. 28 illustrates an embodiment of a process of manufacturing an orthodontic appliance or an orthodontic bracket assembly; and

FIG. 29 illustrates an embodiment of a process of manufacturing orthodontic bracket assemblies.

### DETAILED DESCRIPTION

An orthodontic bracket assembly can generally comprise a bracket portion and a base portion. An orthodontic appliance can comprise a base portion. A bracket portion and a base portion can be separately constructed and then combined to form a bracket assembly. Generally, a bracket portion can include a body comprising a first side and a second side that form opposite sides of the body. Generally, a base portion can comprise a first side and a second side that form opposite sides of the base portion. In some aspects, a second side of a base portion can be configured to contact a surface of a tooth. In some forms, a base portion can be produced by an additive manufacturing process and then combined with a separately formed bracket portion.

An archwire slot can be formed in a body of a bracket portion. In some forms, an archwire slot can be accessible on a first side of a body of a bracket portion. An archwire slot can have an axis configured to lie generally along a mesial-distal direction of a tooth to which a bracket assembly is configured to be attached. In some forms, an archwire slot can comprise a molar tube fixed to or otherwise formed on the first side of the body. In some forms, an archwire slot can be open across a first side of a body of a bracket portion.

A bracket portion can comprise one or more structures for retaining an archwire in an archwire slot. A bracket portion can optionally comprise one or more ligature-retaining structures configured to receive one or more ligatures and retain an archwire. A ligature can generally be attached to one or more ligature-retaining structures to hold an archwire in an archwire slot. In various forms, a ligature can comprise a metal wire, a plastic member, or an elastomeric band that can be attached to a ligature-retaining structure. In some forms, a first side of a body of a bracket portion can comprise at least two ligature-retaining structures, where a first of the ligature-retaining structures extends in a first direction lateral to an archwire slot and a second of the ligature-retaining structures extends in a second direction lateral to the archwire slot. In some forms, the first and second directions can be, respectfully, in a generally gingival direction toward a gum line of a tooth to which a bracket assembly is configured to be attached, and in an occlusal direction generally toward an occlusal plane corresponding to the same tooth. Any ligature-retaining structure extending in an occlusal direction can extend generally at any angle toward an occlusal plane of a tooth to which a bracket assembly is configured to be attached and need not extend orthogonally toward the occlusal plane. Any ligature-retaining structure extending in a gingival direction can extend generally at any angle toward a gum line of a tooth to which a bracket assembly is configured to be attached and need not extend orthogonally toward a gum line. In some forms, a first side of a body of a bracket portion can comprise an occlusal tiewing extending transversely in a generally occlusal direction from an archwire slot and a gingival tiewing extending transversely in a generally gingival direction from the archwire slot. In other aspects, a first side of a body of a bracket portion can comprise a pair of spaced apart occlusal tiewings extending transversely in generally occlusal directions from an archwire slot and a pair of spaced apart gingival tiewings extending transversely in generally gingival directions from the archwire slot.

In other forms, a bracket assembly can include a self-ligating mechanism configured to close over and retain an archwire in an archwire slot. In some forms, a first side of a bracket portion comprises a self-ligating mechanism such as a hinged door, a sliding door, or clasp. A hinged or sliding door or a clasp can be opened to permit insertion of an archwire in an archwire slot and then closed to retain the archwire in the slot. Similarly, a hinged or sliding door or a clasp of a self-ligating mechanism can be opened to permit removal of an archwire from the slot.

One or more of a bracket portion or a base portion of a bracket assembly can optionally comprise a hook configured to retain part of an elastic tie configured to span maxillary and mandibular components of an orthodontic appliance such as braces. In some forms, a tiewing can comprise a hook. In other forms, a hook can be directly formed to a base portion of a bracket assembly. In some forms, a hook can be added to a bracket portion or base portion after a bracket assembly is fixed to a patient's tooth. In some aspects, a bracket portion or base portion can comprise a slot, and hook member can include an end structured to fit within the slot. The end of hook member can be inserted in the slot with the hook extending from the bracket portion or base portion.

Generally, a bracket portion can be affixed to a base portion with a first side of the bracket portion facing away from a first side of the base portion. In some forms, a second side of a bracket portion can be directly affixed to or otherwise bonded to a first side of a base portion. In some aspects, a first side of a base portion can comprise an opening and a bracket can include a post configured to fit in the opening. A post can extend from a second side of the bracket portion and into the opening. In some aspects, an opening can be formed partially into a body of a base portion from the first side of the base portion. In other forms, an opening can pass completely through a body of a base portion from a first side to a second side of the base portion.

In some forms, a base portion can be affixed to a bracket portion using any one or more of thermal bonding (e.g., welding or brazing) and adhesive bonding. In some forms, a first side of a base portion can be welded to a second side of a bracket portion. In other forms, a post of a bracket portion can be welded to an opening of a base portion. In some aspects, a bracket portion and a base portion can be connected by a locking mechanism, morse taper, or any other mechanical structure permitting permanent or semi-permanent connection between a base portion and a bracket portion.

In some forms, a bracket portion can be produced using an additive manufacturing process, an injection molding process, or any other suitable process. In some aspects, a base portion can be formed separately from a bracket portion using an additive manufacturing process such that the base portion comprises one or more different structural features. In some forms, an additive manufacturing process can be used to form a base portion such that a second side of the base portion comprises a base contour structured to receive a surface contour of a patient's tooth to which the second side is configured to be attached. In some aspects, an additive manufacturing process can be used to form a base portion such that a second side of the base portion comprises one or more of a base contour, undercut structures, cavities, and a porous structure. Undercut structures, cavities or porous structures can be configured to receive and retain a desired amount of bonding material or adhesive to be interposed between a surface of a tooth and the second side of the base portion so as to provide strong adhesion of a base portion to a tooth surface.

In some forms, a second side of a base portion can comprise undercut structures, which are thought to aid bonding between a surface of a tooth and the second side by providing increased surface area between the second side and the adhesive and by providing additional structure to retain and anchor bonding material to the base portion. Undercut structures can be produced through additive manufacturing to have any cross-sectional structure such as a hook, a dovetail, or hourglass that extends from the second side of a base portion.

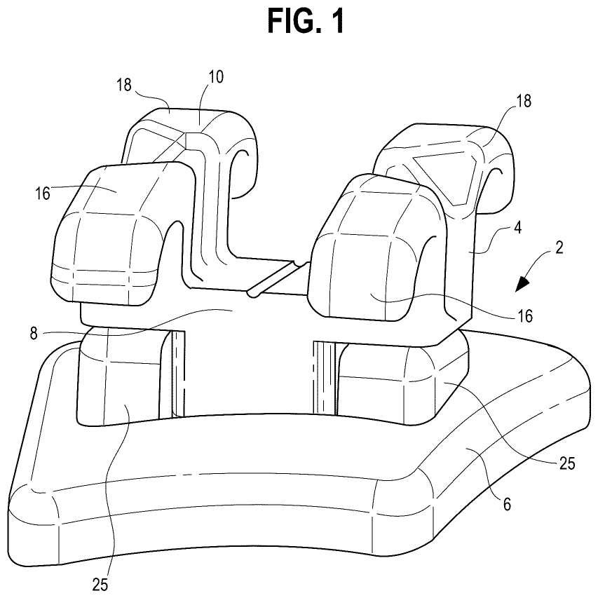

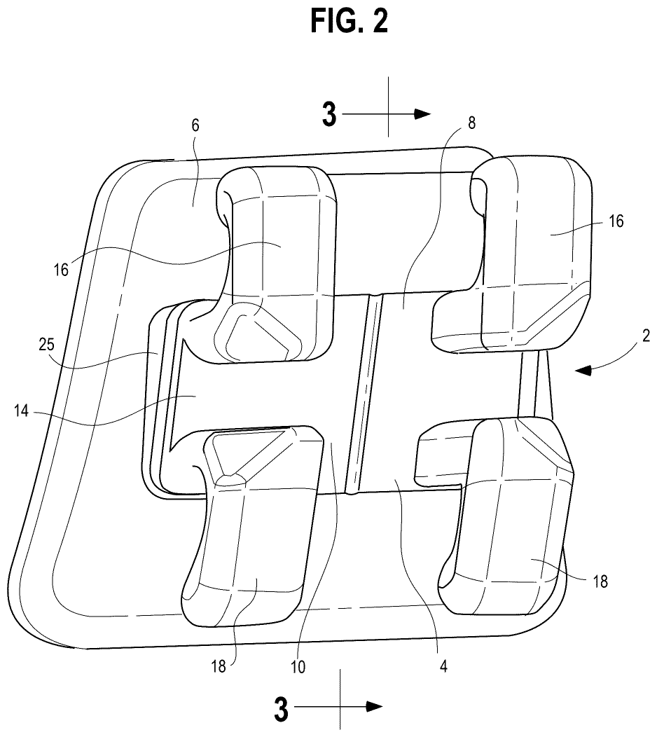

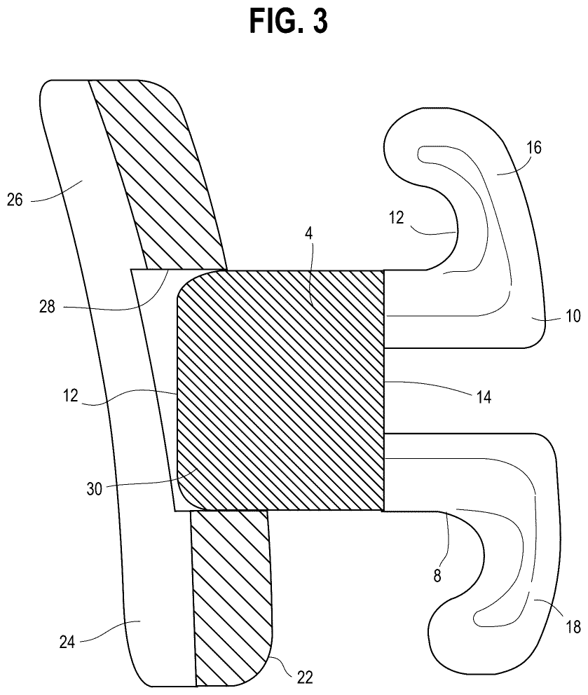

FIGS. 1 and 2 respectfully illustrate front and top perspective views of an embodiment of a bracket assembly 2. FIG. 3 illustrates a cross-sectional view taken along line 3-3 in FIG. 2. The bracket assembly 2 includes a bracket portion 4 and a base portion 6. The bracket portion includes a body 8 comprising a first side 10 and a second side 12. An archwire slot 14 is formed on the first side of the body. The first side of the bracket portion also includes a first pair of tiewings 16 and a second pair of tiewings 18, where the first pair of tiewings 16 generally extend transversely from the archwire slot 14 and the second pair of tiewings 18 generally extend in an opposite transverse direction from the archwire slot 14.

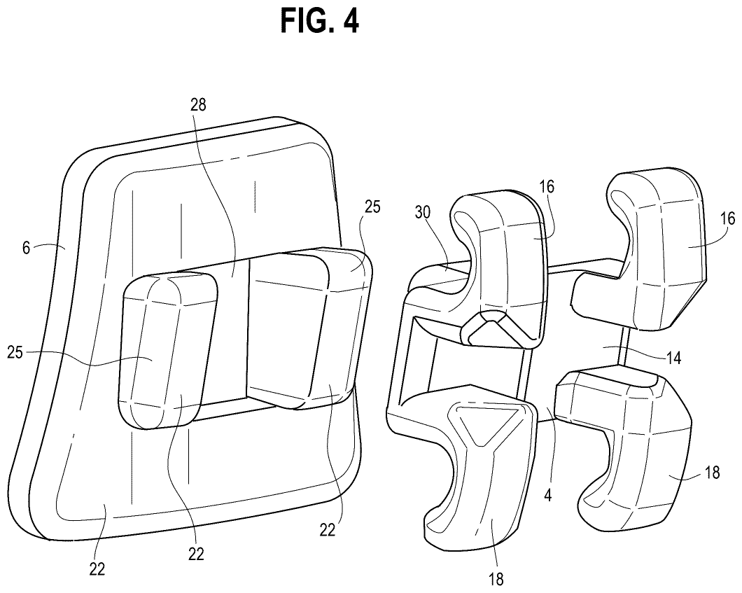

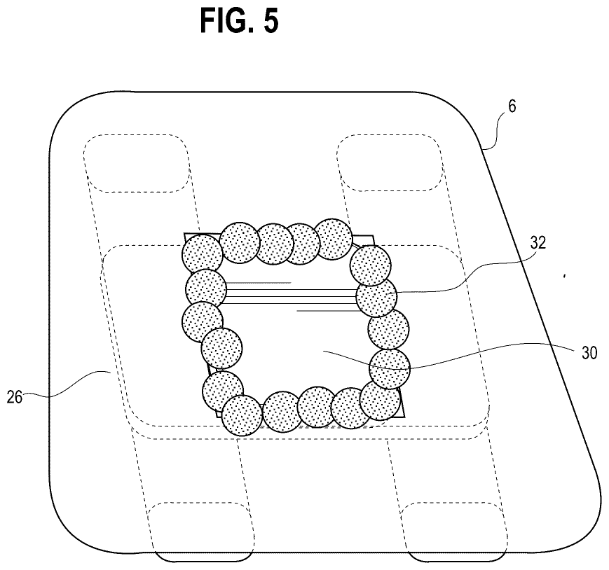

The base portion 6 includes a first side 22 and a second side 24. The bracket portion 4 is affixed to the base portion 6 such that the first side 10 of the bracket portion faces away from the first side of the base portion 22. The second side 24 of the base portion includes a base contour 26 structured to receive a surface contour of a patient's tooth to which the bracket assembly is configured to be attached. The base portion further includes an opening 28 passing from the first side 22 to the second side 24. The bracket portion includes a post 30 extending into the opening 28. FIG. 4 illustrates an unassembled configuration of the bracket assembly shown in FIGS. 1-3, with the post 30 of the bracket portion aligned with the opening 28 in the base portion. FIG. 5 illustrates a backside view of an embodiment of a bracket assembly where a base of a post 30 has been laser welded 32 on a second side the base portion 6.

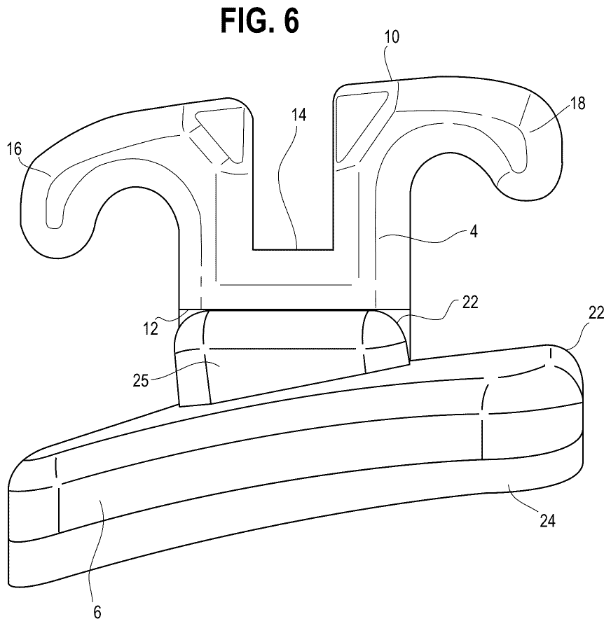

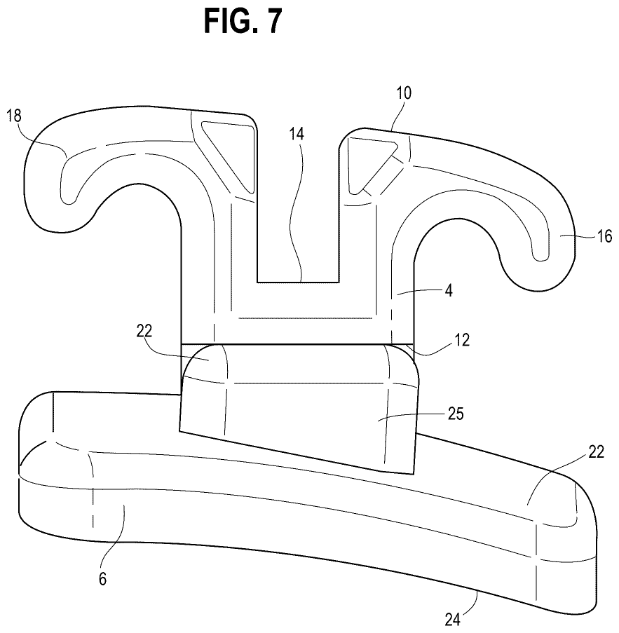

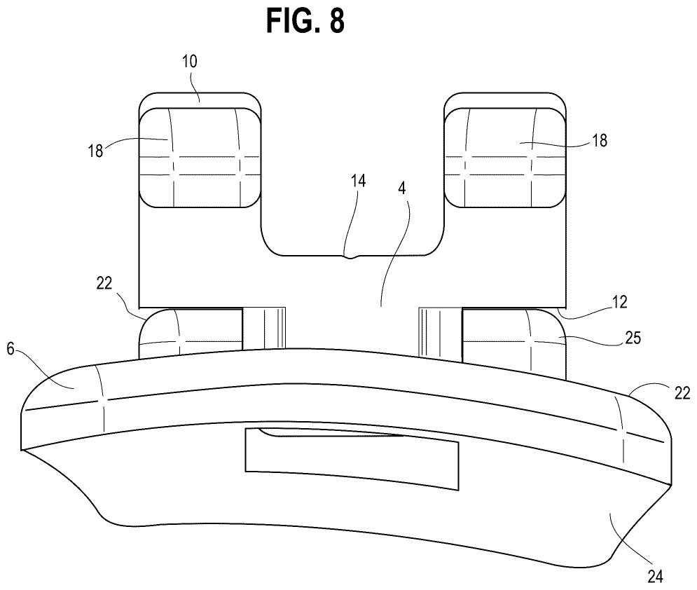

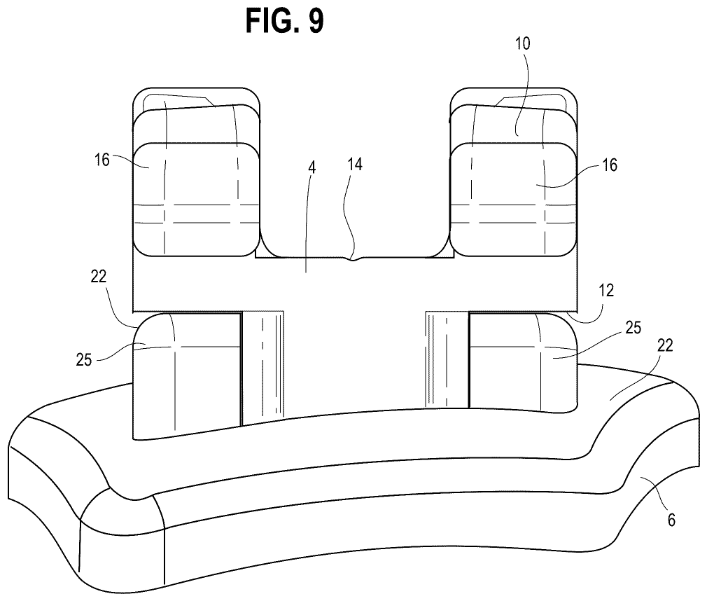

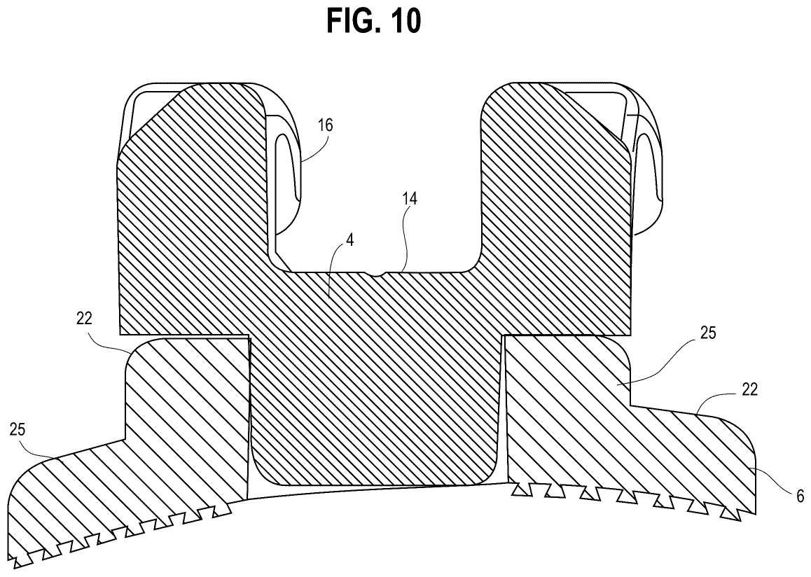

FIGS. 6 and 7 are opposite side elevational views along the axis of the archwire slot 14 of the bracket assembly 2 shown in FIG. 1. FIG. 8 is an occlusal side elevational view and FIG. 9 is a gingival side elevational view of the bracket assembly 2 shown in FIG. 1. The base portion 6 includes supports 25. FIGS. 4 and 6-9 show that the second side 12 of the bracket portion 4 rests on the supports 25.

In some embodiments, supports can be formed to impart one or more of torque angle, offset angle, or in-out distance, as provided herein. In other embodiments, a base portion can be formed to have any cross-sectional dimensions and angles from the mesial to distal, occlusal to gingival, and any thickness to impart these angular and dimensional characteristics.

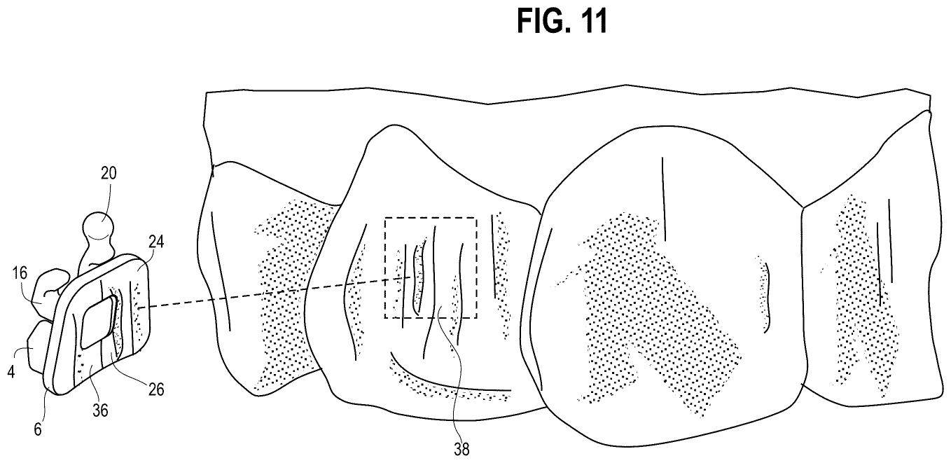

FIG. 10 illustrates a cross-section of an embodiment of a bracket assembly where the second side 24 of a base portion 6 comprises undercut structures 34. When the second side of the base portion is attached to a surface of a tooth using an adhesive, the undercut structures provide the second side of the base portion with increased surface area for contact with the adhesive.

In some forms, a base portion can be formed by an additive manufacturing process to comprise a plurality of networked cavities disposed between first and second sides of the base portion. In some forms, cavities can be formed by one or more layers comprising spaced apart objects. In some aspects, a base portion comprising spaced apart objects can be formed by an additive manufacturing process comprising depositing material to form one or more layers of spaced apart objects, with spaces between the spaced apart objects forming a plurality of cavities. Spaced apart objects can each have the same three-dimensional structure or different three-dimensional structures. In some aspects, one or more of top and bottom edges of spaced apart objects in a particular layer of a base portion can contact edges of laterally offset spaced apart objects in one or more adjacent layers included in a base portion. In some aspects, spaced apart objects can generally have any structure such as cuboid, cylindrical, or a structure comprising two identical polygon-shaped sides separated by rectangular surface sides. In some forms, widths or diameters of objects exceeds heights of the objects, where height is measured along an axis from a first side to a second side of a base portion.

In some aspects, an additive manufacturing process can be used to form a base portion comprising an open porous structure analogous to a sponge where cavities are formed by a network of pores in the base portion. In some forms, an additive manufacturing process can comprise depositing material to establish a network of pores throughout a solid structure. Cavities or pores within a base portion can be configured to receive bonding material interposed between a surface of a tooth and a second side of the base portion. Cavities and pores are generally thought to aid retention of the base portion to the surface of the tooth by providing additional surface area for bonding between a base portion and an adhesive.

In some aspects a base portion can be formed by an additive manufacturing process to comprise one or more layers of material formed into a mesh structure, a lattice structure, or a structure resembling a woven structure. In some aspects, an additive manufacturing process can be used to form a base portion by depositing strips of material to form a pattern of a mesh, a pattern of a lattice, or a pattern resembling a woven structure.

Generally, a bracket portion and a base portion of a bracket assembly can be independently constructed to provide a bracket assembly with customized characteristics. In some forms, a bracket portion and a base portion can be formed separately using different processes. Materials used to construct a bracket portion and a base portion can be different or the same. In some aspects, a base portion of a bracket assembly can be constructed using any type of additive manufacturing process using any material of construction, and a bracket portion can be constructed using any type of manufacturing process such as injection molding or additive manufacturing using any material of construction. In some forms, a bracket portion is not made by an additive manufacturing process. In some aspects, a base portion can be constructed separately from a bracket portion by additive manufacturing based on a three-dimensional model of a patient's dentition.

Examples of useful additive manufacturing processes include binder jetting, directed energy deposition, direct metal laser sintering, material extrusion, material jetting, powder bed fusion, sheet lamination, and vat polymerization. Examples of materials that can be used to construct an object using additive manufacturing include polymers, metals, ceramics, and composites. An additive manufacturing process can be controlled by a computing device programmed to control process parameters of an additive manufacturing apparatus to construct a three-dimensional object such as a base portion.

In some forms, a base portion can be constructed using a direct metal laser sintering process where a laser selectively sinters and fuses together metal particles to form a layer, and the laser subsequently sinters and fuses additional metal particles to the initial layer to build additional layers and construct a three-dimensional object such as a base portion.

In other forms, an additive manufacturing process can comprise depositing a layer of metal powder on a bed and selectively curing the powder and then depositing another layer of metal powder and selectively curing the powder to build up a pattern of a structure. In some aspects, selective curing can be achieved by irradiating each layer of powder with a laser. Excess powder can be removed and the object or base portion can be subjected to one or more sintering processes to fuse metal particles together. In some forms, a binder and powder can be deposited to produce a layer. Additional powder and binder can be applied to produce one or more additional layers. A resultant “green” part includes the binder and powder and can be sintered to produce an object.

In some forms, an additive manufacturing process can comprise depositing a ceramic powder and selectively curing the powder. One or more additional layers of ceramic powder can be deposited on a previous layer and selectively cured to produce an object. In some forms, an additive manufacturing process can comprise depositing resinous material and then curing the material. In some aspects, an additive manufacturing process can comprise stereolithography (SLA) including curing each layer of resinous material with a laser or point cure by tracing a 2D map for a particular layer of a structure. In some forms, an additive manufacturing process can comprise digital light projection (DLP) including curing a layer of resinous material with a pattern of light emitted from a projector where the pattern of light provides a curing map for the layer. In yet another aspect, an additive manufacturing process can comprise fused deposition modeling (FDM) including extruding resinous material through a patterned die and depositing the extruded material to form a layer. The pattern of extruded material and the location of deposition can form the structure of each deposited layer.

Examples of injection molding processes include metal injection molding, ceramic injection molding, and plastic injection molding. Examples of materials can be used for injection molding include metal such as stainless steel, ceramic material, resinous and polymeric material. In some forms, metal injection molding can include injecting a pelletized metal including a fraction of wax or plastic under high heat and pressure into a mold form. A molded object in green form can be removed from the mold and then sintered to remove the wax or plastic and fuse the metal particles together into a cohesive whole. Such a metal injection molded object can be optionally polished to provide a high degree of shine. In some forms, an injection molded part can be polished by subjecting the part to a process of tumbling in a tumbling media, such as metal T-pins. In other forms, an injection molded part can be polished by an electropolishing process. It is generally thought that a metal injection molded part can be polished to high luster because metal injection molded materials generally have a non-porous surface of densely packed metal material.

In some forms, a bracket portion of a bracket assembly can be constructed by a process comprising injection molding and a base portion can be produced by an additive manufacturing process and then combined with the injection molded bracket portion. In some embodiments, a bracket portion is constructed by a process comprising metal injection molding and then the bracket portion is polished; and a base portion is constructed from metal using an additive manufacturing process and then combined with the polished, metal injection molded bracket portion. It is thought that combining a polished metal injection molded bracket portion with a base portion produced by additive manufacturing can provide a combination of beneficial effects. A polished metal injection molded bracket portion can provide an outward appearance that is normally associated with metal injection molded brackets. Some patients may prefer such an outward appearance of polished metal over a less lustrous appearance that can be associated with additive manufacturing using metal materials. Also, it is thought that an archwire slot formed in a polished metal injection molded bracket portion can provide relatively smoother archwire sliding mechanics than a slot having rough surfaces formed by other processes such as additive manufacturing. A base portion constructed using additive manufacturing can include a base contour configured to closely receive a surface contour of a patient's tooth. In some forms, a base portion can comprise a custom base contour configured to closely accept a surface contour, or provide a negative impression of a surface contour, of a tooth to which the base portion is configured to be attached. In addition, a base portion can be constructed using additive manufacturing to have undercut structures or a plurality of cavities, as provided herein, whereas it may be more difficult to form bonding structures on a base of a single piece metal injection molded bracket. In addition, it is generally thought that a porous nature of some embodiments of base portions produced by an additive manufacturing process can provide enhanced adhesion to an adhesive material disposed between a tooth and a base portion.

A bracket assembly including a bracket portion produced by metal injection molding can also provide an advantage that the bracket portion can exhibit a high degree of dimensional accuracy, such as a precise width of an archwire slot. Such high dimensional accuracy might in some cases be difficult to achieve through additive manufacturing of a bracket portion. However, a base portion produced by additive manufacturing could be combined with such a bracket portion produced by metal injection molding and the base portion could provide a benefit of having a custom base contour prepared to conform to a patient's tooth.

In other forms, a base portion can be constructed using a ceramic-based additive manufacturing process and combined with a bracket portion produced by ceramic injection molding. In yet other aspects, a base portion can be constructed using a resin-based additive manufacturing process and combined with a plastic injection molded bracket portion. In yet other embodiments, a base portion can be constructed using a metal additive manufacturing process and combined with a bracket portion produced by plastic injection molding. In another form, a base portion can be constructed using a resin additive manufacturing process and combined with a ceramic injection molded bracket portion. It should be noted that these combinations of material and methods of construction of a base portion and a bracket portion are not limiting. Any useful additive manufacturing process and material can be used to construct a base portion, and any useful manufacturing process can be used to construct a bracket portion.

Some orthodontic brackets can be constructed in one piece by processes such as injection molding or additive manufacturing such that the bracket includes an integrated base. However, it has been found that a bracket assembly as provided herein including a base portion that is separately formed by an additive manufacturing process can provide benefits over brackets formed in one-piece by processes such as injection molding or additive manufacturing. When constructing one-piece brackets including bases by injection molding, a manufacturer may need to produce a very large number of molds to produce one-piece brackets to cover not only a desired number of orthodontic prescriptions but to also cover a wide variety of possible tooth shapes for each prescription. In some forms, a bracket assembly permits selection of a bracket portion from an array of bracket portions covering a number of different orthodontic prescriptions without regard to a surface contour of a tooth. A base portion can be constructed independent from the bracket portion using additive manufacturing to include a base contour configured to receive a surface contour of a patient's tooth. A selected bracket portion can then be combined with base portion produced by additive manufacturing to produce a bracket assembly. It is thought that a bracket assembly can eliminate the need to produce a very large number of molds and brackets having, for each orthodontic prescription, different base shapes to accommodate the wide variety of possible tooth structures. It is also thought that a bracket assembly can provide an advantage over one-piece brackets produced by additive manufacturing, because the time required to construct a base portion of a bracket assembly using a given additive manufacturing process can be less than the time required to produce an entire one-piece bracket including an integrated base and bracket parts using the same additive manufacturing process.

It is also generally thought that one-piece brackets can be difficult to debond from a tooth because the bracket has a stiff structure. In some cases, a one-piece bracket may “snap” off a tooth. This may be undesirable desirable because it may cause pain to a patient. It is generally thought that use of additive manufacturing to form a base portion permits precise control of a cross section of a base portion, which may permit easier and more flexible debonding from a tooth.

As noted above, a base portion can comprise a second side comprising a base contour structured to receive a surface contour of a patient's tooth depicted in a three-dimensional model of the patient's dentition. A three-dimensional model can include surface topography information or surface contours of one or more of a patient's teeth or a patient's complete set of teeth. An electronic file can comprise a three-dimensional model of a patient's dentition that has been captured either directly from a patient's dentition or indirectly from an impression model of a patient's dentition. Examples of useful devices for measuring topography information from a patient's dentition include intraoral scan, cone beam computed tomography taken directly from a patient's dentition or indirectly from an impression model, and a laser scan of an impression model. The measured topography information can be processed by a computing device. The topography information can be generally saved in any useful format such as point cloud data or any useful file utilized in computer-aided drafting (CAD). The information can be saved using any useful type of memory such as RAM, a solid-state drive, a hard disk, a network drive, or a cloud-based server. A computing device can be programmed to generate a three-dimensional model of a patient's dentition based on the topography information.

Examples of a computing device useful in processes and methods provided herein include one or more of a personal computer, a network of computers such as computers connected to one or more of a local area network, a wireless network, a cellular network, and a cloud network.

A base contour of a bracket of an orthodontic bracket assembly can be calculated from a surface contour of a tooth depicted in a three-dimensional model of a patient's dentition. In some forms, a structure of a base contour can be calculated as a negative impression of a surface contour of the patient's tooth depicted in a three-dimensional model. In some aspects, a negative impression for a base contour can be calculated by performing a Boolean subtract of a surface contour of a patient's tooth in a three-dimensional model.

In some forms, a Boolean subtract can be formed by three-dimensionally modelling a tooth and a base portion, with a base contour on a second side of the base portion intersecting and overlapping a surface contour of the tooth in the three-dimensional model. The three-dimensional model of the surface contour of the patient's tooth can be subtracted from the second side of the three-dimensional model of the base portion to create a negative impression of the surface contour of the tooth in the base contour of the base portion.

In some forms, a surface contour of a patient's tooth can be rendered as a point cloud of multiple surfaces, and a base contour on a second side of a base portion can be extruded or otherwise formed as a negative of the point cloud to create a negative impression of the surface contour of the tooth in the base contour of the base portion.

A base contour calculated as a negative impression can provide an inverse structure of a surface contour of a patient's tooth included in a three-dimensional model. This inverse structure permits a close fit between a surface of a tooth and a base contour. It is generally thought that such a close fit advantageously permits the use of less bonding material between a base portion and a tooth because few gaps will be present between the tooth and the base portion. It is also thought use of minimal bonding material can help avoid potential points of weakness normally present in a relatively thicker layer of bonding material. It is also thought that a base portion comprising a base contour formed as a negative impression of a surface contour of a tooth can aid in placement of the base portion and a bracket assembly on the tooth because the base contour will noticeably conform to the surface contour when properly positioned. This correspondence between a surface contour of a tooth and a base contour of a base portion can aid in reducing error when positioning base portions of bracket assemblies on teeth. FIG. 11 illustrates an embodiment of a bracket assembly 2 including a bracket portion 4 and a base portion 6, where the second side of the base portion includes a negative impression 36 of a surface contour 38 of a patient's tooth. The negative impression of the base portion is configured to be positioned on the surface contour.

In some forms, a base contour can be calculated by performing mathematical best fit approximations along two or more intersecting radii that lie on and traverse a surface contour of a patient's tooth depicted in a three-dimensional model of a patient's dentition. In some forms, a radius as provided herein can generally lie in any direction across a surface contour of a tooth depicted in a three-dimensional model when viewing a facial surface of the tooth, and conform to a surface contour of the tooth when viewing a cross-section of the tooth normal to the surface contour taken along the radius. In some aspects, a base contour can be calculated by mathematical best fit approximations along at least one radius oriented in a first direction across a surface contour of a tooth depicted in a three-dimensional model and at least one radius oriented in a second direction across the surface contour, where the radius oriented in the first direction intersects the radius oriented in the second direction.

An angle of intersection of two or more radii can generally be orthogonal or any angle offset from orthogonal. In some forms, a base contour can be calculated by mathematical best fit approximations along plural spaced apart and parallel radii oriented in a first direction across a surface contour of a tooth depicted in a three-dimensional model and plural spaced apart and parallel radii oriented in a second direction across the surface contour, where the radii oriented in the first direction intersect with the radii oriented in the second direction on a facial surface of a tooth.

In some forms mathematical best fit approximations can be made on a base contour of an already formed base portion. In some aspects, a process can comprise performing a first mathematical best fit approximation of a base contour of a base portion in a first direction across the base contour and a second mathematical best fit approximation of the base contour in a second direction across the base contour, where the first direction is different from and intersects the second direction at a centroid of the second side of the base portion. The first and second directions can each be linear across a base contour. In some forms, a process can comprise performing a first mathematical best fit approximation of a second side of the base portion along a radius oriented in an occlusal-gingival direction and a second mathematical best fit approximation of the second side of the base portion along a radius oriented in a mesial-distal direction, such that the radii oriented in the mesial-distal and occlusal-gingival directions intersect at a centroid of the second side of the base portion.

In some forms, a mathematical best fit approximation can determine a best fit curve from a set of topographical datapoints along a radius lying across a surface contour of a tooth depicted in a three-dimensional model of a patient's dentition. In some forms, topographical datapoints can represent a surface contour of the tooth when viewing a cross-section of the tooth normal to the surface contour taken along the radius.

In some aspects, a mathematical best fit approximation can determine a best fit curve from a set of topographical datapoints across one or more directions across a base contour of a base portion. In some forms, topographical datapoints can represent a base contour when viewing a cross-section of the base portion normal to the base contour taken along the direction.

Examples of best fit approximations include linear regression, least squares regression, interpolation, or other mathematical modeling techniques.

In some forms, a Facial Axis of the Clinical Crown (FACC) can be the long axis of any tooth that is centered mesial-distal on the facial surface of the clinical crown. For molars, the FACC can be the line running down the buccal groove of the clinical crown. The Focal Axis (FA) point can be the midpoint of the FACC. The Andrews plane can be a plane created by the FA points across a level arch. An Andrew's plane can exist for the mandible and an Andrew's plane can exist for the maxilla. Andrew's planes may or may not be level with the occlusal plane.

In some forms, a radius can be oriented along a mesial-distal direction. In some aspects, a mesial-distal direction can be along or parallel to an archwire plane or an Andrews plane of a tooth to which a bracket assembly is configured to be attached. In some forms, a radius can be oriented along an occlusal-gingival direction. In some aspects, an occlusal-gingival direction can be along or parallel to a root axis of a tooth to which a bracket assembly is configured to be attached. In some forms, a radius can be oriented along an occlusal-gingival direction can follow the tip angle of the tooth, which is not necessarily orthogonal to an archwire plane or an Andrews plane.

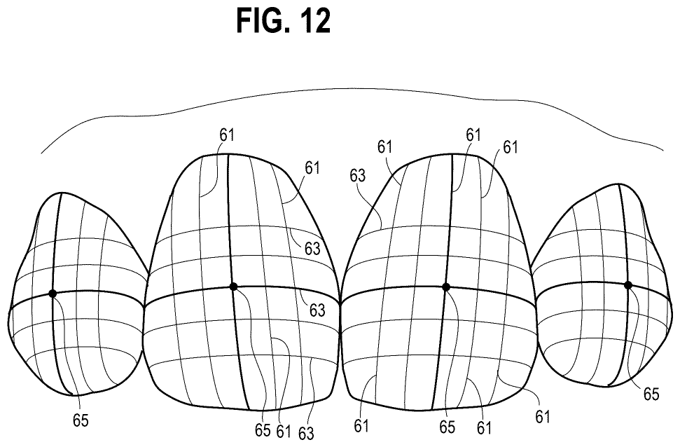

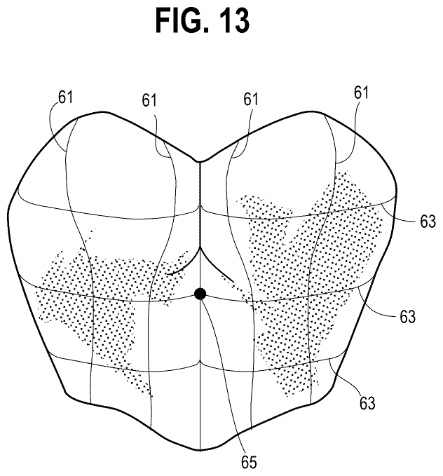

In some forms, a base contour can be calculated by mathematical best fit approximations along at least one radius oriented in a mesial-distal direction across a surface contour of a tooth depicted in a three-dimensional model and at least one radius oriented in an occlusal-gingival direction across the surface contour. A radius oriented in a mesial-distal direction can intersect with a radius oriented in an occlusal-gingival direction. The angle of intersection of radii can be any angle such as orthogonal or generally any angle offset from orthogonal. In some forms, a base contour can be calculated by mathematical best fit approximations along plural spaced apart and parallel radii oriented in a mesial-distal direction across a surface contour of a tooth depicted in a three-dimensional model and plural spaced apart and parallel radii oriented in an occlusal-gingival direction across the surface contour. FIG. 12 illustrates an embodiment of a series of teeth along a maxillary arch. The teeth include plural radii 61 oriented along an occlusal-gingival direction and plural radii 63 oriented along a mesial-distal direction. FIG. 13 illustrates an embodiment of a molar with plural radii 61 oriented along an occlusal-gingival direction and plural radii 63 oriented along a mesial-distal direction. In FIGS. 12 and 13, a bonding point 65 is located at an intersection of radii.

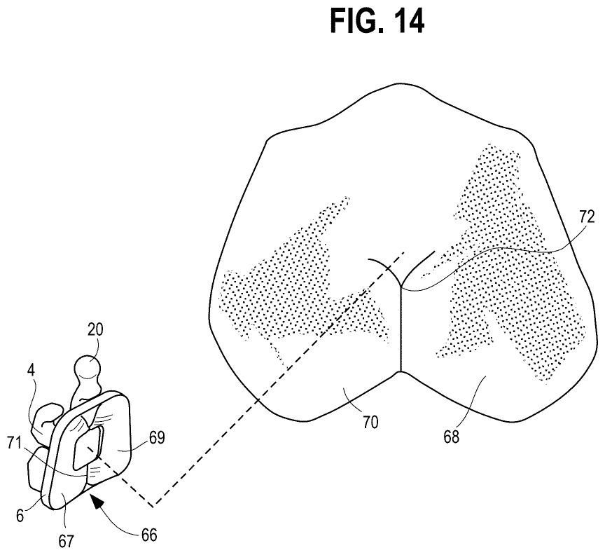

In some forms, at least one radius oriented in a mesial-distal direction can include plural arcuate curves when viewed at a cross-section of a tooth normal to a surface contour taken along at least one radius. In some forms, at least one radius oriented in an occlusal-gingival direction includes plural arcuate curves when viewed at a cross-section of a tooth normal to a surface contour taken along at least one radius. In some aspects, plural arcuate curves can account for structures such as buccal pit and buccal groove forming multiple contours on a surface of a tooth. FIG. 14 illustrates an embodiment of a bracket assembly 2 including a bracket portion 4 and a base portion 6. The second side of the base portion includes a base contour 66 that has been calculated by a plurality of radii oriented in a first direction and a plurality of radii oriented in a second direction across a surface contour of a tooth depicted in a three-dimensional model. The base contour includes best fit curves calculated from at least two intersecting lines across a mesial-buccal cusp 68 and at least two intersecting lines across a disto-buccal cusp 70 of a molar, with a ridge corresponding to a buccal groove between the curves. The base contour also includes best fit curves approximating radii surrounding a buccal pit 72.

In some forms, a base portion can be constructed to have a base contour configured to interface with a surface contour of a tooth at the FA point. In other forms, a base portion can be constructed to have a base contour configured to interface with a surface contour of a tooth at a position offset in any direction from the FA point. In some forms, where a radius oriented in a mesial-distal direction of a tooth coincides with the Andrews plane of the tooth and a radius oriented in an occlusal-gingival direction of the tooth coincides with the FACC of the tooth, the FA point can be the point of intersection of the radius oriented in the mesial-distal direction and the radius oriented in an occlusal-gingival direction.

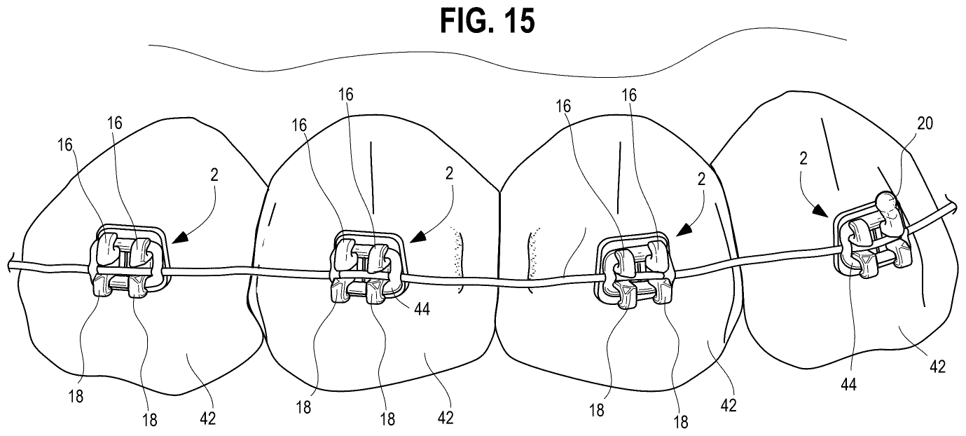

FIG. 15 illustrates an embodiment including four bracket assemblies 2 as provided herein, which are separately affixed to four different teeth 42. An archwire 40 is disposed through archwire slots in the bracket assemblies. Ligatures 44 retain the archwire in the archwire slots.

A bracket assembly can comprise an orthodontic prescription including any one or more of torque angle, in-out distance, offset angle and tip angle. In some forms, a bracket assembly includes an orthodontic prescription including torque angle and in-out distance and optionally one or more of offset angle and tip angle.

The ISO 27020 standard, Second Edition, 2019-6, is incorporated herein by reference in its entirety. In an aspect, angle of torque can be occlusal-gingival angle formed between the intersection of the line perpendicular to the tangent to the tooth side surface of the base and the line bisecting the slot in the occlusal-gingival direction, when viewed along the mesial-distal long-axis of the slot, as stated the ISO 27020 standard.

In some forms, torque angle can be configured to exist between an occlusal plane formed by a patient's tooth and a line normal to a floor of the archwire slot and bisecting the archwire slot, when viewing along an axis of the archwire slot at a cross-section of the bracket assembly taken along an occlusal-gingival direction through a centroid of a second side of a base portion upon affixing the second side of the base portion to the patient's tooth.

In some aspects, at least a portion of torque angle can be incorporated into a bracket portion or a base portion of a bracket assembly. In some forms, a torque angle can be incorporated into a bracket portion and a base portion of a bracket assembly. In some aspects, a torque angle can be incorporated into a bracket portion but not a base portion of a bracket assembly. In other forms, a torque angle can be incorporated into a base portion but not a bracket portion of a bracket assembly.

In some forms, at a cross-section of a bracket assembly along an occlusal-gingival direction through a centroid of a second side of a base portion and viewed along an axis of an archwire slot, a torque angle can be measured between a first line (a) and a second line (b). The first line (a) can be parallel to or lying across a floor of an archwire slot. The second line (b) can intersect a third line (c) at the centroid of the second side of the base portion, with the second line (b) being orthogonal to the third line (c). At the centroid of the second side of a base portion, the third line (c) can be normal to at least both a mathematical best fit curve of a base contour on a second side of the base portion along a first direction and a mathematical best fit curve of the base contour along a second direction, where the first direction is different from the second direction. In some aspects, torque angle incorporated in a bracket portion can be measured between the first line (a) and a fourth line (d). The fourth line (d) can exist within a plane resting on at least three points of a facial-most surface of a first side of a body of the bracket portion. In some forms, torque angle incorporated in a base portion can be measured between the second line (b) and the fourth line (d).

In some aspects, torque angle can range from −35 to +35 degrees, −30 to +30 degrees, −25 to +25 degrees, or −20 to +20 degrees. In some forms, an amount of torque angle incorporated in a bracket portion can range from −30 degrees to +30 degrees, −25 degrees to +25 degrees, −20 degrees to +20 degrees, or −15 degrees to +15 degrees. In some aspects, an amount of torque angle incorporated in a base portion can range from −7 degrees to +7 degrees, −5 degrees to +5 degrees, −3 degrees to +3 degrees, or −2 degrees to +2 degrees.

In an aspect, in-out can be a distance between the floor of the slot and the tooth side surface of the base/band, as stated the ISO 27020 standard. In some forms, bracket in-out distance can be distance between the floor of the slot and the tooth side surface of the base/band along the intersection of the plane perpendicular to mesial-distal long-axis of the slot in the center of the bracket slot and the plane bisecting the slot in the occlusal-gingival direction, when viewed along the mesial-distal long-axis of the slot, as stated the ISO 27020 standard.

In some forms, at a cross-section of a bracket assembly along an occlusal-gingival direction through a centroid of a second side of a base portion and viewed along an axis of an archwire slot, in-out distance can be a length of a line having an endpoint at a center point of a floor of an archwire slot and an endpoint at the centroid on the second side of the base portion, with the center point of the floor of the archwire slot equidistant from opposing walls of the archwire slot. In some aspects, portions of in-out distance are incorporated in a base portion and a bracket portion. In some forms, a portion of in-out distance incorporated in a bracket portion can be measured between the endpoint of the line at the center point of the floor of the archwire slot and a point on the line on a second side of the bracket portion. In some aspects, a portion of in-out distance incorporated in the bracket portion can be measured between the point on the line on the second side of the bracket portion and the centroid of a second side of a base portion.

In some forms, in-out distance can range from 0.025 inches to 0.050 inches, 0.030 inches to 0.040 inches, or 0.032 inches to 0.038 inches. In some aspects, an in-out distance incorporated in a bracket portion can range from 0.015 inches to 0.035 inches, from 0.020 inches to 0.030 inches, from 0.023 inches to 0.028 inches, or be 0.025 inches. In some forms, an in-out distance incorporated in a base portion can range from 0.00 inches to 0.035 inches, from 0.01 inches to 0.03 inches, or from 0.02 inches to 0.025 inches.

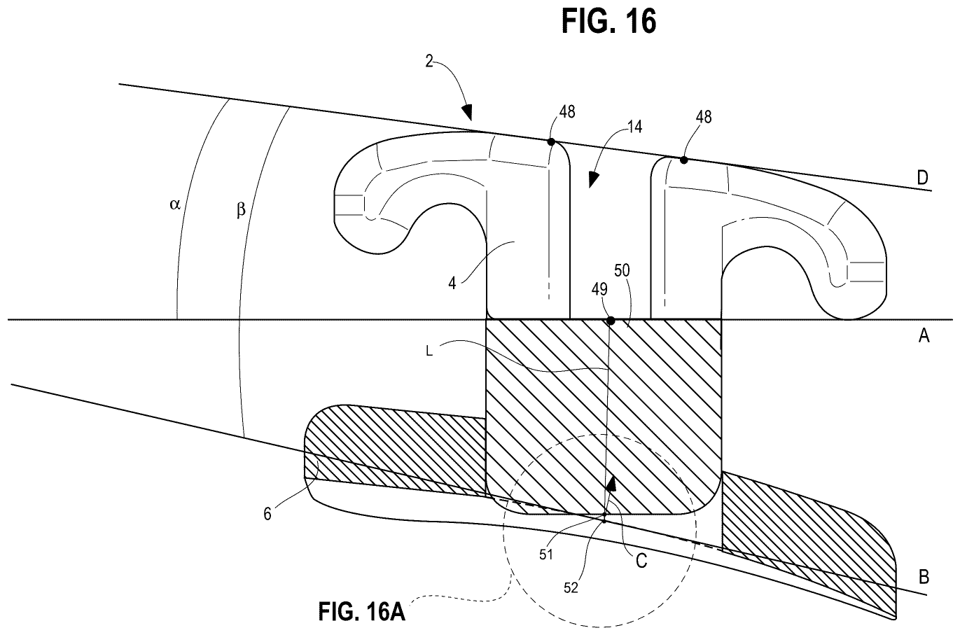

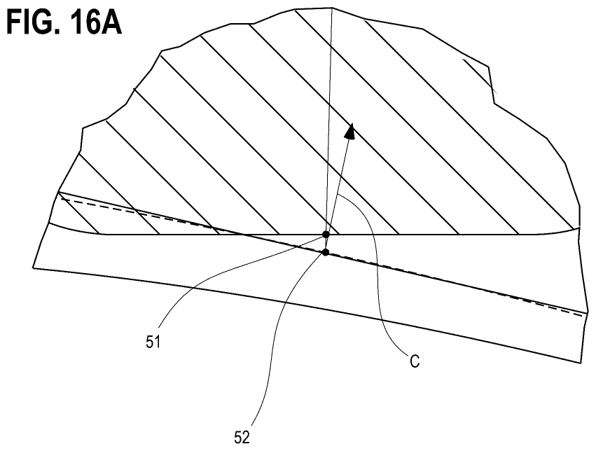

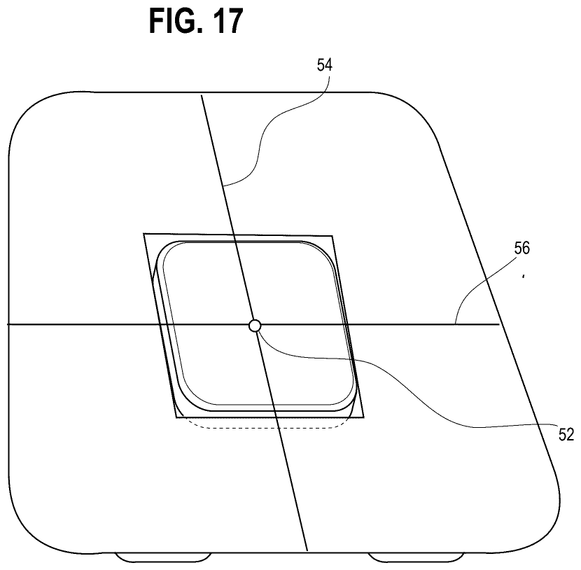

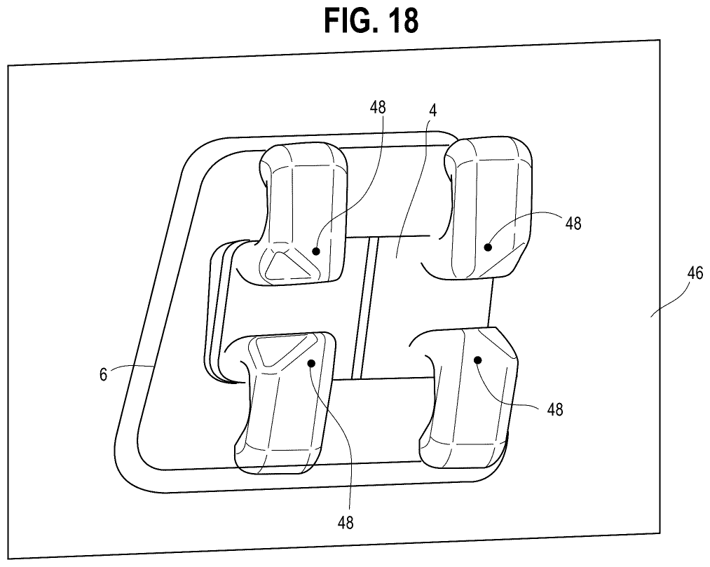

FIG. 16 illustrates a cross-section along an occlusal-gingival direction through a centroid of the second side of the base portion 6 the bracket assembly 2 shown in FIG. 1, viewed along an axis of the archwire slot 14. In FIG. 16, torque angle exists between a line (A) lying across a bottom 50 of the archwire slot 14 and a line (B). The line (B) intersects and is orthogonal to a line (C) at a point 52 at the centroid of the second side of the base portion 6. FIG. 17 illustrates point of intersection 52 of a mathematical best fit curve of the base contour on the second side of the base portion along the occlusal-gingival direction 54 and a mathematical best fit curve of the base contour along a mesial-distal direction 56. At the point of intersection 52, line (C) is in FIG. 16 normal to both the mathematical best fit curve along the occlusal-gingival direction 54 and the mathematical best fit curve of the base contour along the mesial-distal direction 56. In FIG. 16, an amount of torque angle (alpha—α) incorporated in the bracket portion 4 exists between the line (A) and a line (D). FIG. 18 illustrates top perspective view of a plane 46 resting on at least three points 48 of a facial-most surface of the first side of the body of the bracket portion shown in FIGS. 1 and 16. FIG. 16 shows two of the points 48 in FIG. 18. Line (D) in FIG. 16 is within the plane 46 in FIG. 18. In FIG. 16, an amount of torque angle (beta—β) incorporated in a base portion 6 is measured between line (B) and line (D). If the bracket assembly shown in FIG. 16 were attached to a tooth in a maxillary arch, the illustrated torque angle would be positive.

In the embodiment shown in FIG. 16, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. FIG. 16A illustrates an enlarged portion of the second side of the bracket portion in FIG. 16. In-out distance incorporated the base portion 6 is a length of a segment of line (L) between point 51 and point 52.

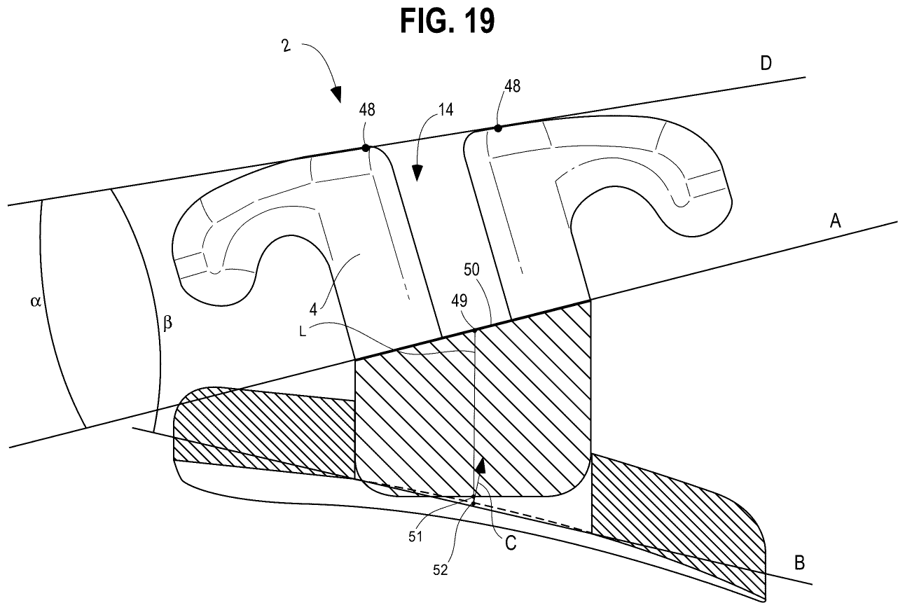

FIG. 19 illustrates a cross-section along an occlusal-gingival direction through a centroid of a second side of a base portion 6 of another embodiment of bracket assembly 2, viewed along an axis of the archwire slot 14. In FIG. 19, an amount of torque angle (beta—β) incorporated in the base portion 6 is measured between a line (B) and a line (D). Line (D) is within a plane resting on at least three points 48 (two of which are illustrated) of a facial-most surface of the first side of the body of the bracket portion 4. The line (B) intersects and is orthogonal to a line (C) at a point 52 at the centroid of the second side of the base portion 6. At point 52, line (C) is normal to both a mathematical best fit curve of the base contour on the second side of the base portion along the occlusal-gingival direction and a mathematical best fit curve of the base contour along a mesial-distal direction. In FIG. 19, an amount of torque angle (alpha—α) incorporated in the bracket portion 4 is measured between line (D) and a line (A) along the floor 50 of the archwire slot 14. The amount of torque angle (beta—β) incorporated in the base portion in the embodiment shown in FIG. 19 is greater than the amount of torque angle (beta—β) incorporated in the base portion in the embodiment shown in FIG. 16.

In the embodiment shown in FIG. 19, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. In-out distance incorporated the base portion 6 is a length of a segment of line (L) between point 51 and point 52.

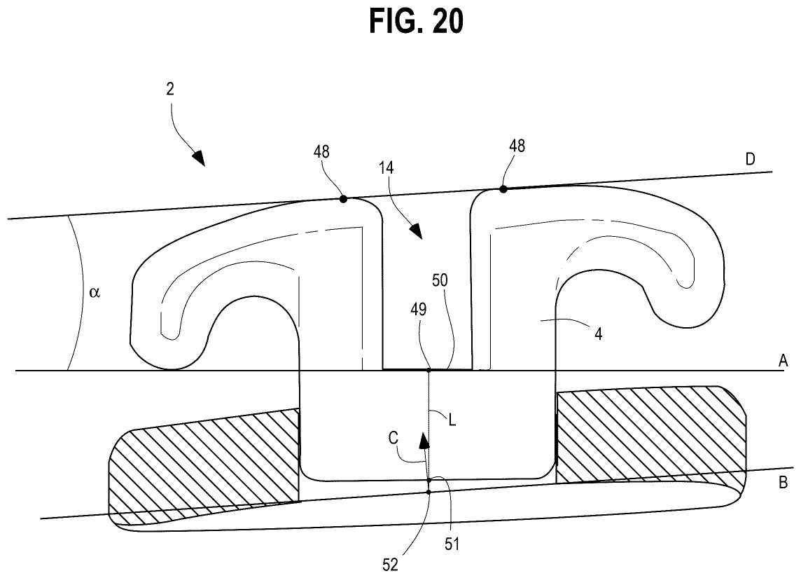

FIG. 20 illustrates a cross-section along an occlusal-gingival direction through a centroid of a second side of a base portion 6 of another embodiment of bracket assembly 2, viewed along an axis of the archwire slot 14. Line (D) is within a plane resting on at least three points 48 (two of which are illustrated) of a facial-most surface of the first side of the body of the bracket portion 4. Line (B) intersects and is orthogonal to a line (C) at a point 52 at the centroid of the second side of the base portion 6. At point 52, line (C) is normal to both a mathematical best fit curve of a base contour on the second side of the base portion along the occlusal-gingival direction and a mathematical best fit curve of the base contour along a mesial-distal direction. No torque angle is incorporated into the base portion 6 because lines (B) and (D) are parallel. In FIG. 20, an amount of torque angle (alpha—α) incorporated into the bracket portion 4 is measured between line (D) and line (A) along the floor 50 of the archwire slot 14.

In the embodiment shown in FIG. 20, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. In-out distance incorporated the base portion 6 is a length of a segment of line (L) between point 51 and point 52.

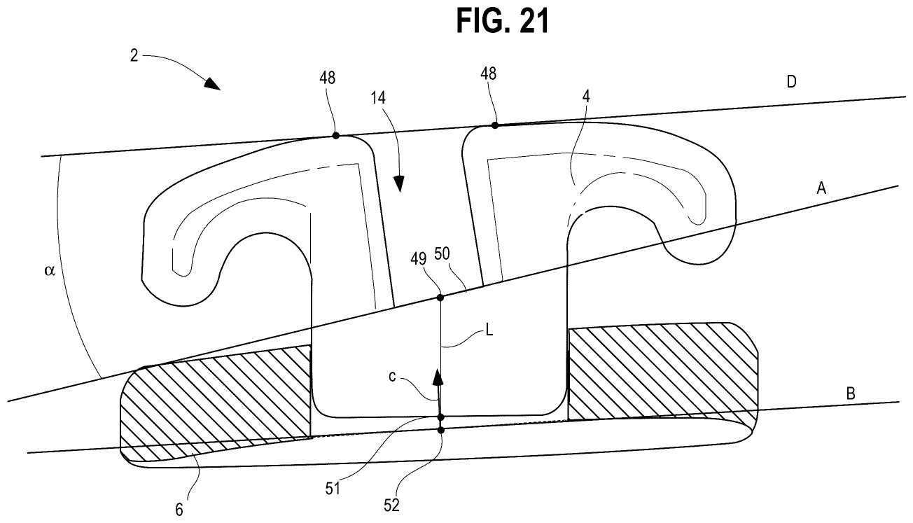

FIG. 21 illustrates a cross-section along an occlusal-gingival direction through a centroid of a second side of a base portion 6 of another embodiment of bracket assembly 2, viewed along an axis of the archwire slot 14. Line (D) is within a plane resting on at least three points 48 (two of which are illustrated) of a facial-most surface of the first side of the body of the bracket portion 4. The line (B) intersects and is orthogonal to a line (C) at a point 52 at the centroid of the second side of the base portion 6. At point 52, line (C) is normal to both a mathematical best fit curve of the base contour on the second side of the base portion along the occlusal-gingival direction and a mathematical best fit curve of the base contour along a mesial-distal direction. In FIG. 21, no torque angle exists in the base portion 6 because lines line (B) and line (D) are parallel. In FIG. 21, an amount of torque angle (alpha—α) incorporated in the bracket portion 4 is measured between line (D) and a line (A) along the floor 50 of the archwire slot 14.

In the embodiment shown in FIG. 21, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. In-out distance incorporated the base portion 6 is a length of a segment of line (L) between point 51 and point 52.

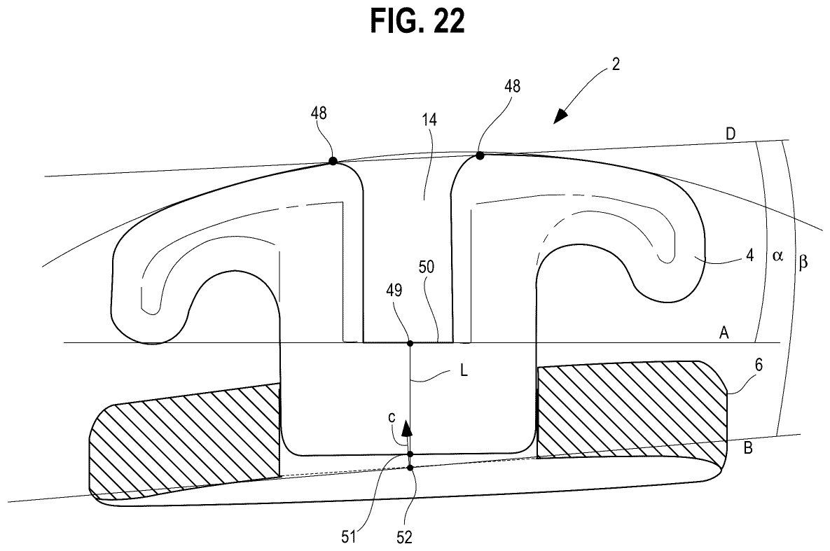

FIG. 22 illustrates a cross-section along an occlusal-gingival direction through a centroid of a second side of a base portion 6 of another embodiment of bracket assembly 2, viewed along an axis of the archwire slot 14. In FIG. 22, an amount of torque angle (beta—β) incorporated in the base portion 6 is measured between a line (B) and a line (D). Line (D) is within a plane resting on at least three points 48 (two of which are illustrated) of a curved facial-most surface of a first side of the body of the bracket portion 4. Line (B) intersects and is orthogonal to a line (C) at a point 52 at the centroid of the second side of the base portion 6. At point 52, line (C) is normal both a mathematical best fit curve of the base contour on the second side of the base portion along the occlusal-gingival direction and a mathematical best fit curve of the base contour along a mesial-distal direction. An amount of torque angle (alpha—α) incorporated in the bracket portion 4 is measured between the line (D) and a line (A) along the floor 50 of the archwire slot 14.

In the embodiment shown in FIG. 22, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. In-out distance incorporated the base portion 6 is a length of a segment of line (L) between point 51 and point 52.

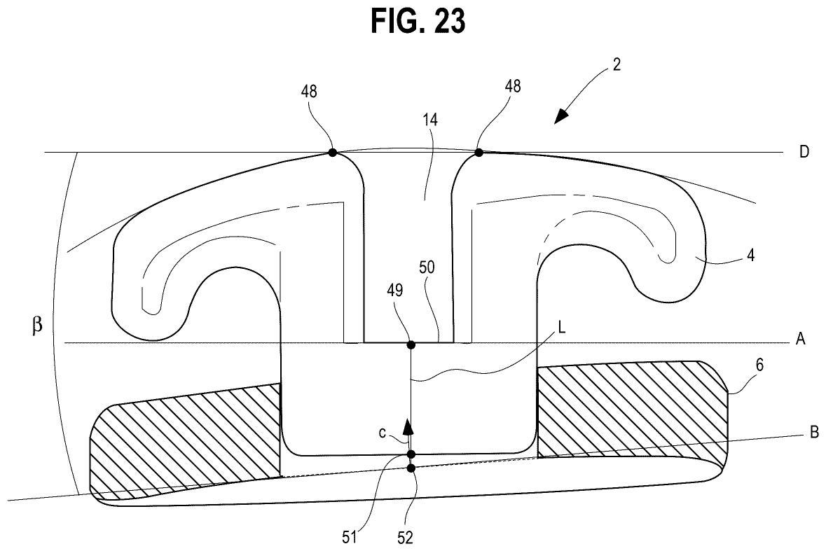

FIG. 23 illustrates a cross-section along an occlusal-gingival direction through a centroid of a second side of a base portion 6 of another embodiment of bracket assembly 2, viewed along an axis of the archwire slot 14. In FIG. 23, an amount of torque angle (beta—β) incorporated in the base portion 6 is measured between a line (B) and a line (D). Line (D) is within a plane resting on at least three points 48 (two of which are illustrated) of a curved facial-most surface of the first side of the body of the bracket portion 4. Line (B) intersects and is orthogonal to a line (C) at a point 52 at the centroid of the second side of the base portion 6. At point 52, line (C) is normal both a mathematical best fit curve of the base contour on the second side of the base portion along the occlusal-gingival direction and a mathematical best fit curve of the base contour along a mesial-distal direction. In FIG. 23, no torque angle is incorporated into the bracket portion 4 because the line (D) is parallel to a line (A) along the floor 50 of the archwire slot 14.

In the embodiment shown in FIG. 23, in-out distance is the length of line (L) between a center point 49 of a floor 50 of an archwire slot 14 and point 52 at the centroid on the second side of the base portion, where center point 49 is equidistant from opposing walls of the archwire slot. In-out distance incorporated the bracket portion 4 is the length of a segment of line (L) between point 49 and point 51 where line (L) intersects a second side of the bracket portion. In-out distance incorporated the base portion 6 is a length of a segment of line (L) between point 51 and point 52.

In an aspect, rotational offset can be angle between a line parallel to the floor of the slot and the line connecting the points of intersection of the lines along the mesial and distal end-faces of the slot at the tooth side surface of the base, when viewed from the occlusal, as stated the ISO 27020 standard.

In some aspects, at a cross-section of a bracket assembly along a mesial-distal direction through a centroid of a second side of a base portion and viewed from an occlusal side, offset angle can exist between a first line (e) along or parallel to a floor of an archwire slot and a second line (f). The second line (f) can intersect a third line (g) at the centroid of the second side of the base portion and the second line (f) can be orthogonal to the third line (g). At the centroid of the second side of the base portion the third line (g) can be normal at least both a mathematical best fit curve of a base contour of the second side of the base portion along a first direction and a mathematical best fit curve of the base contour along a second direction, where the first direction is different from the second direction. In some aspects, at least a portion of offset angle can be incorporated into a bracket portion or a base portion of a bracket assembly. In some forms, an offset angle can be incorporated into a bracket portion and a base portion of a bracket assembly. In some aspects, an offset angle can be incorporated into a bracket portion but not a base portion of a bracket assembly. In other forms, an offset angle can be incorporated into a base portion but not a bracket portion of a bracket assembly. In some aspects, offset angle incorporated in a bracket portion can be measured between the first line (e) and a fourth line (h). The fourth line (h) can exist within a plane resting on at least three points of a facial-most surface of a first side of a body of the bracket portion. In some forms, offset angle incorporated in a base portion can be measured between the second line (f) and the fourth line (h). In some aspects, offset angle can range from −20 degrees to +20 degrees, −15 degrees to +15 degrees, or −12 degrees to +12 degrees. In some forms, an amount of offset angle incorporated in a bracket portion can range from +20 degrees to −20 degrees, +15 degrees to −15 degrees, +7 degrees to −7 degrees, +5 degrees to −5 degrees, or +3 degrees to −3 degrees. In some forms, an amount of offset angle incorporated in a base portion can range +17 degrees to −17 degrees, +15 degrees to −15 degrees, from +13 degrees to −13 degrees, from +5 degrees to −5 degrees. In some forms, no offset angle can be incorporated one or both of the bracket portion and the base portion. In some forms of bracket assemblies including a molar tube, an offset angle can range from +20 degrees to −20 degrees.

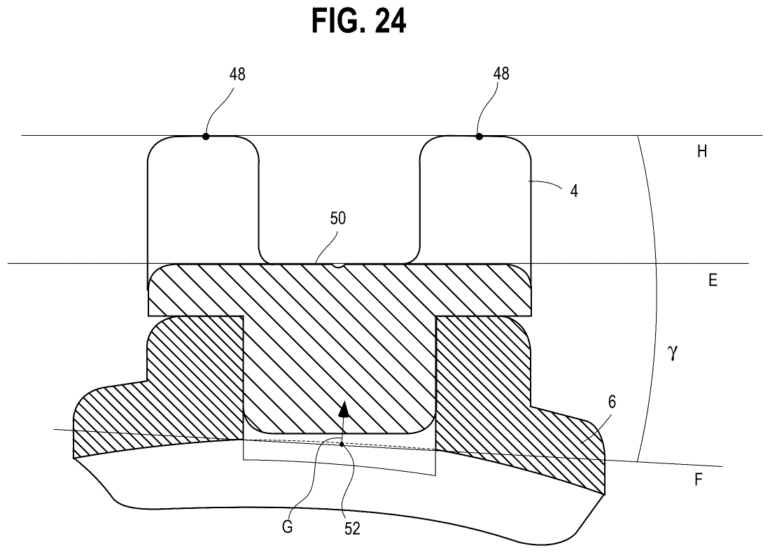

FIG. 24 illustrates a cross-section along a mesial-distal direction through a centroid of the second surface of the base portion of the bracket assembly shown in FIG. 1 viewed from an occlusal side. In FIG. 24, an amount of offset angle (gamma—γ) incorporated in the base portion exists between a line (F) and line (H). Line (F) intersects and is orthogonal to a line (G) at a point 52 at the centroid of the second surface of the base portion 6. At the point of intersection 52, line (G) is normal to both a mathematical best fit curve of the base contour on the second side of the base portion along the occlusal-gingival direction 54 and a mathematical best fit curve of the base contour along a mesial-distal direction 56, as shown in FIG. 17. FIG. 18 illustrates front perspective view of a plane 46 resting on at least three points 48 of a facial-most surface of the first side of the body of the bracket portion shown in FIGS. 1 and 16. FIG. 24 shows two of the points 48 in FIG. 18. Line (H) in FIG. 24 is within the plane 46 in FIG. 18. Line (E) in FIG. 24 is along the floor 50 of the archwire slot. In FIG. 24, no offset angle exists in the bracket portion 4 because line (E) is parallel to line (H).

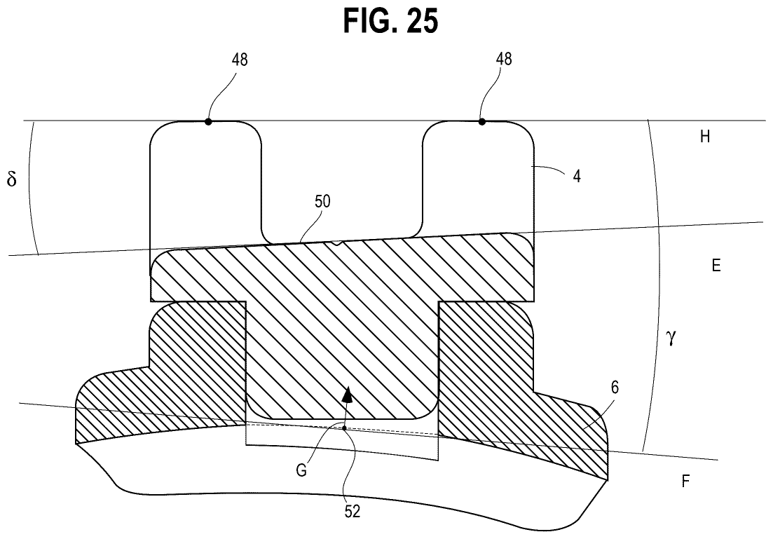

FIG. 25 illustrates a cross-section along a mesial-distal direction through a centroid of a second surface of a base portion of an embodiment of a bracket assembly, viewed from an occlusal side. In FIG. 25, an amount of offset angle (delta—δ) incorporated in the bracket portion 4 exists between a line (E) across the floor 50 of the archwire slot and a line (H). Line (H) is within a plane resting on at least three points 48 (two of which are illustrated) of a facial-most surface of the first side of the body of the bracket portion 4. An amount of offset angle (gamma—γ) incorporated in the base portion 6 exists between line (H) and a line (F). Line (F) intersects and is orthogonal to a line (G) at a point 52 at the centroid of the second surface of the base portion 6. At the point of intersection 52, line (G) is normal to both a mathematical best fit curve of the base contour on the second side of the base portion along the occlusal-gingival direction and a mathematical best fit curve of the base contour along a mesial-distal direction. In FIG. 25, a sum angle (gamma—γ) and angle (delta—δ) provide the overall offset angle.

When viewing a facial aspect of a tooth, tip angle can generally be an angle between the crown long axis of the tooth to which the bracket assembly is to be attached and a line that is both orthogonal to the axis of the archwire slot and parallel to the floor of the archwire slot.

In some aspects, at least a portion of tip angle can be incorporated into a bracket portion or a base portion of a bracket assembly. In some forms, tip angle can be incorporated into a bracket portion and a base portion of a bracket assembly. In some aspects, a tip angle can be incorporated into a bracket portion but not a base portion of a bracket assembly. In other forms, a tip angle can be incorporated into a base portion but not a bracket portion of a bracket assembly.

In some forms, tip angle incorporated into a base portion can be measured between a line (i) along a mesial edge or distal edge of the base portion and a line (j) that is both orthogonal to the axis of the archwire slot and parallel to the floor of the archwire slot, when viewing a facial aspect. It this thought that tip angle incorporated in a base portion can aid visual orientation of the base portion on a tooth so that an edge of the base portion can be generally parallel to an edge of the tooth. In some forms, all tip angle can be incorporated into a base portion. In some forms, tip angle incorporated into a bracket portion can be measured between a line (k) formed along a mesial or distal edge of a base of a bracket portion and a line (j) that is both orthogonal to the axis of the archwire slot and parallel to the floor of the archwire slot, when viewing a facial aspect. In some forms, an amount of tip angle incorporated in a bracket portion can be a closest fit to overall tip angle. In some forms, overall tip angle can exist between line (k) and line (i). An amount of tip angle can range from −15 degrees to +15 degrees, −10 degrees to +10 degrees, or −5 degrees to +5 degrees. In some forms, a bracket assembly includes no tip angle. In some forms, an amount of tip angle incorporated in a bracket portion can range from −10 degrees to +10 degrees, from −8 degrees to +8 degrees, from −4 degrees to +4 degrees, or 0 degrees. In some aspects, an amount of tip angle incorporated in a base portion can range from −11 degrees to +11 degrees, from −7 degrees to +7 degrees, from −5 degrees to +5 degrees, or 0 degrees.

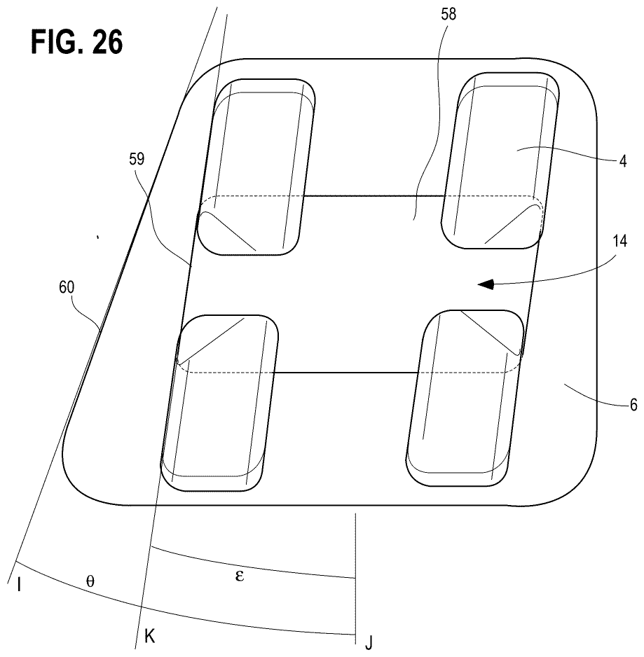

FIG. 26 illustrates plan view of the bracket assembly shown in FIG. 1, viewed from a facial aspect. In FIG. 26, an amount of tip angle (epsilon—ε) incorporated in the bracket portion 4 exists between line (K) formed along a mesial edge 59 of a base 28 of a bracket portion 4 and a line (J) that is both orthogonal to the axis of the archwire slot 14 and parallel to the floor of the archwire slot. In FIG. 26, an amount of tip angle (theta—θ) incorporated into the base portion 6 exists between line (I) along a mesial edge 60 base portion 6 and a line (J).

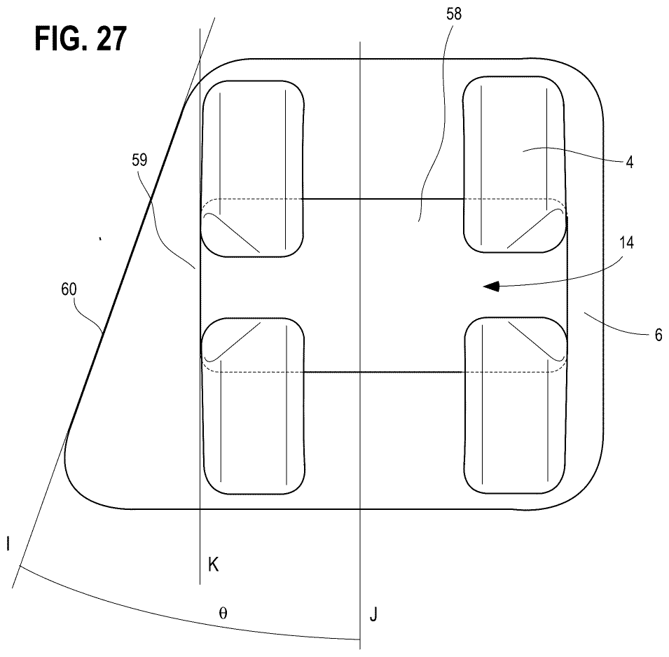

FIG. 27 illustrates plan view of another embodiment of a bracket assembly from a facial aspect. In FIG. 27, an amount of tip angle (theta—θ) incorporated into the base portion 6 exists between line (I) along a mesial edge 60 base portion 6 and a line (J). The embodiment shown in FIG. 27 does not include tip angle incorporated into the bracket portion.

A process of manufacturing an orthodontic appliance can generally include forming a base portion by an additive manufacturing process. A process of manufacturing an orthodontic bracket assembly can generally include forming a base portion by an additive manufacturing process and affixing a bracket portion to the base portion. A base portion can be formed to generally have a first side and a second side. An additive manufacturing process can structure a second side of the base portion to include a base contour structured to receive a surface contour of a patient's tooth to which the second side of the base portion is configured to be attached.

A process of manufacturing one or more bracket assemblies can also include providing one or more bracket portions including a body comprising a first side, a second side, and an archwire slot formed on the first side. In some forms, providing a bracket portion can comprise selecting a bracket portion from a group of different bracket portions based on one or more of an orthodontic prescription for a tooth to which a bracket assembly including the bracket portion is to be attached, material of construction of the bracket portion, and a process by which the bracket portion was made. In some forms a bracket portion is produced by a process, e.g., injection molding, different from additive manufacturing used to produce a base portion. In some aspects, a process of manufacturing one or more bracket assemblies can also include producing one or more bracket portions.

A process can comprise calculating a base contour by any one or methods of calculation. In some forms a process can comprise calculating a negative impression of a surface contour of a patient's tooth depicted in a three-dimensional model of the patient's dentition. In some aspects, a process can comprise performing best fit approximations along two or more intersecting lines traversing a surface contour of a patient's tooth depicted in a three-dimensional model of the patient's dentition. In some forms a process can comprise performing mathematical best fit approximations along at least one radius oriented in a first direction across a surface contour of a tooth depicted in a three-dimensional model and at least one radius oriented in a second direction across the surface contour, where the radius oriented in the first direction intersects the radius oriented in the second direction. In some forms, a process can comprise performing mathematical best fit approximations along at least one radius oriented along a mesial-distal direction across a surface contour of a tooth depicted in a three-dimensional model and at least one radius oriented in along an occlusal-gingival direction across the same surface contour, where the at least one radius oriented along a mesial-distal direction intersects the at least one radius oriented along an occlusal-gingival direction. In some forms, a process can comprise performing mathematical best fit approximations along plural different radii oriented along a mesial-distal direction across a surface contour of a tooth depicted in a three-dimensional model and plural different radii oriented along an occlusal-gingival direction across the surface contour.

In some aspects, a process can comprise performing mathematical best fit approximations along at least one radius oriented along a mesial-distal direction and at least one radius oriented along an occlusal-gingival direction across a surface contour of a tooth depicted in a three-dimensional model, wherein the at least one radius oriented along a mesial-distal direction includes plural arcuate curves when viewed at a cross-section of the tooth normal to the surface contour taken along the at least one radius oriented in along a mesial-distal direction, and the at least one radius oriented along a occlusal-gingival direction includes plural arcuate curves when viewed at a cross-section of the tooth normal to the surface contour taken along the at least one radius oriented along a occlusal-gingival direction. In some forms, a process can comprise performing mathematical best fit approximations along plural different radii oriented along a mesial-distal direction, and plural different radii oriented along an occlusal-gingival direction across a surface contour of a tooth depicted in a three-dimensional model.

In some forms, a process of manufacturing one or more orthodontic bracket assemblies can comprise importing to a computing device a three-dimensional model obtained from a patient's dentition. In other forms, a process can comprise saving to a computing device a three-dimensional model obtained from a patient's dentition, for example when the computing device receives and processes measured topography information for a patient's dentition, generates the three-dimensional model from the measured topography information, and saves the three-dimensional model.

A process of manufacturing an orthodontic appliance or an orthodontic bracket assembly can comprise using a computing device to calculate a base contour from a surface contour of a tooth depicted in a three-dimensional model of a patient's dentition that has been imported or saved to a computing device. In some forms, a process can comprise calculating a plurality of base contours from a plurality of surface contours of teeth depicted in a three-dimensional model. In some embodiments, a process comprises calculating a base contour by any one or methods of calculation such as calculating a negative impression of a surface contour of a patient's tooth depicted in a three-dimensional model of the patient's dentition, and performing best fit approximations along two or more intersecting lines or radii depicted in a three-dimensional model of the patient's dentition.

In some forms, a process of manufacturing an orthodontic appliance or an orthodontic bracket assembly can include forming a base portion using an additive manufacturing process where the additive manufacturing process uses base portion structure data to form a base portion. In some forms, base portion structure data can be generated in a computing device operating software such as CAD software. Generally, base portion structure data can be used to control an additive manufacturing process to build a body of a base portion. A computing device reading base portion structure data can control an additive manufacturing apparatus to build a base portion. Base portion structure data can generally include instructions for building an entire base portion including a second side comprising a base contour. Base portion structure data can include general structure data for a base portion such as perimeter shape and thickness. Base portion structure data can optionally include instructions to form one or more of an opening in a base portion configured to receive a post of a bracket assembly. A computing device can use base portion structure data to control an additive manufacturing process to form the base portion to comprise a structure depicted in the base portion structure data and to include a second side comprising a calculated base contour. Similarly, a process can include forming a plurality of base portions using an additive manufacturing process such that the additive manufacturing process uses base portion structure data for the plurality of teeth.

In some aspects, processes of manufacturing an orthodontic appliance or an orthodontic bracket assembly can include using an additive manufacturing process to form a plurality of undercut structures on the second side of the base portion and also form the second side to include a base contour structured to receive a surface contour of a patient's tooth to which the second side of the base portion is configured to be attached.

In some forms, a process of manufacturing an orthodontic appliance or an orthodontic bracket assembly can include using an additive manufacturing process to form a base portion including a plurality of layers and a plurality of cavities spanning the layers.

In some aspects, an additive manufacturing process can comprise depositing a first layer including a first plurality of spaced apart objects, and subsequently deposit a second layer comprising a second plurality of spaced apart objects laterally offset from the first plurality of spaced apart objects. An additive manufacturing process can optionally further deposit a third or even more layers each including a plurality of spaced apart objects offset from objects deposited in immediately adjacent layer. An additive manufacturing process can comprise forming a plurality of spaced apart objects for each layer where the objects have any structure such as cuboid, cylindrical, or a structure comprising two identical polygon-shaped sides separated by rectangular surface sides. In some forms, an additive manufacturing process can comprise depositing a plurality of spaced apart objects having widths or diameters that exceed heights of the objects, where height is measured along an axis from a first side to a second side of a base portion. An additive manufacturing process can comprise depositing one or more of the layers including spaced apart objects to form a second side of a base portion including a base contour structured to receive a surface contour of a patient's tooth depicted in the three-dimensional model of the patient's dentition, with the plurality of cavities exposed on the second side. An additive manufacturing process can comprise depositing a layer to comprise a first side of a base portion. An additive manufacturing process can deposit the first side as a solid surface not exposing the plurality of cavities in layers between the first side and the second side. An additive manufacturing process can comprise forming an opening in the base portion where the opening passes from a first side to a second side of the base portion.

In other forms, an additive manufacturing process can comprise sequentially depositing layers while forming pores or other cavities by deposition of the layers to form a base portion. The porous structure can be formed mimic organic structures such as a porous sponge. In some forms, an additive manufacturing process can comprise sequentially depositing layers to form pores or cavities such that a pore or cavity density is consistent on a second side of a base portion.

In some forms, a process of manufacturing one or more orthodontic bracket assemblies can include designing an orthodontic bracket set based on an information set. In some forms, an information set comprises one or more of: (a) a three-dimensional model of a patient's dentition, (b) an orthodontic prescription for the patient's dentition, and (c) one or more base contours calculated from the three-dimensional model. In some forms, an orthodontic prescription includes any one or more of (1) tooth position (e.g., tooth number 1-32; or maxillary/mandibular, left/right numbered 1 (central) through 7 (second molar)), (2) tip angle, (3) torque angle, (4) offset angle, (5) in-out distance, (6) archwire slot size (width of slot), and (7) hooked vs. non-hooked. Any portion or an entirety of an information set can be imported or saved to a computing device. In some forms, a computing device can be programmed to generate an orthodontic bracket set using one or more of variables (a)-(c) to create one or more bracket assembly models. The program can design the one or more bracket assembly models to fit surface contours of the patient's teeth and to provide prescribed movement of teeth in the patient's dentition over a time. Each bracket assembly model can comprise bracket portion structure data and base portion structure data including a base contour corresponding to a specific tooth.

In some forms. a process of manufacturing one or more orthodontic bracket assemblies can comprise constructing a base portion by an additive manufacturing process using base portion structure data such that the constructed base portion comprises a first side and a second side, and the second side comprises a base contour structured to receive the surface contour of a specific tooth.

In some aspects, a process of manufacturing one or more orthodontic bracket assemblies can comprise providing a bracket portion for a bracket assembly based on bracket portion structure data. In some forms, bracket portion structure data provides guidance for selection of a bracket portion from a group or array of premade bracket portions covering a variety of different orthodontic prescriptions, from a group or array of premade bracket portions including a variety of different materials of construction, and from a group or array of premade bracket portions made by variety of different processes. In some forms, a bracket assembly can be selected from bracket assemblies made by injection molding. In some embodiments, a bracket assembly can be selected from bracket assemblies made by metal injection molding that have been polished. In some forms, a process can comprise constructing one or more bracket portions by any useful process and from any useful material as needed to complete one or more bracket assemblies by combining with one or more corresponding base portions.

A process of manufacturing one or more orthodontic bracket assemblies can further comprise affixing a bracket portion to a base portion. In some forms, a bracket portion is affixed to base portion with the first side of the base portion proximal the second side of the body of the bracket portion. In some forms, a process can comprise affixing a second side of a body of a bracket portion to a first side of a base portion. As provided herein, any useful process such as a thermal bonding process (e.g., welding), adhesive bonding, or an interlocking mechanism can be used to affix a bracket portion to a base portion. In some forms, a process comprises inserting a post comprised on a second side of a bracket portion into an opening comprised in a base portion and welding the post to the base portion.

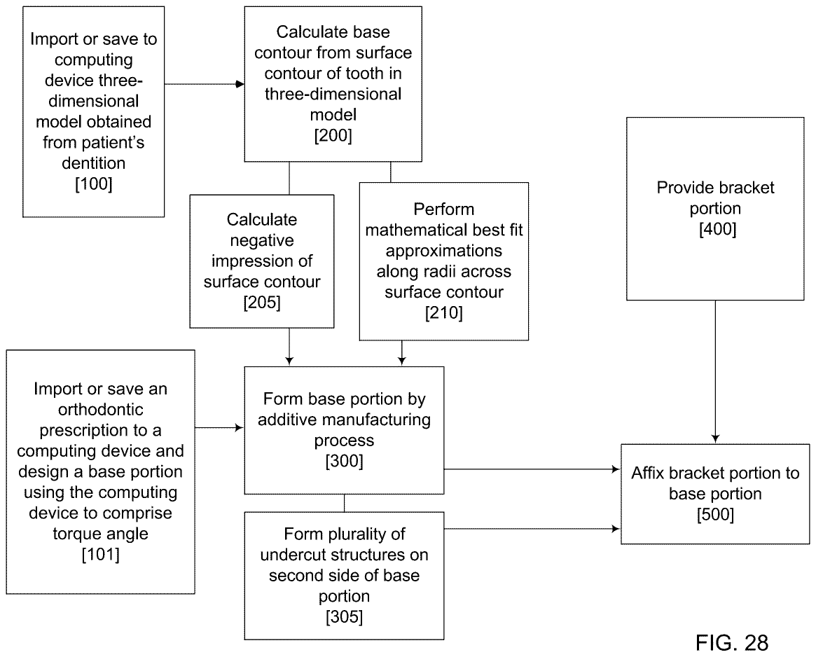

FIG. 28 illustrates an embodiment of a process of manufacturing an orthodontic appliance or an orthodontic bracket assembly, which includes importing or saving to a computing device a three-dimensional model obtained from a patient's dentition 100. The process in FIG. 28 also includes importing or saving an orthodontic prescription to a computing device and designing the base portion using the computing device to comprise the torque angle 101. The process also includes calculating a base contour from a surface contour of the patient's tooth depicted in the three-dimensional model 200. In some forms, calculating the base contour comprises calculating a negative impression of the surface contour of the patient's tooth depicted in the three-dimensional model 205. In some aspects, calculating the base contour comprises performing mathematical best fit approximations along a radius oriented in a first direction across a surface contour of a tooth depicted in a three-dimensional model and radius oriented in a second direction across the surface contour 210, where the radius oriented in the first direction intersects the radius oriented in the second direction. The process in FIG. 28 also includes forming a base portion by an additive manufacturing process, such that the base portion comprises a first side and a second side. The additive manufacturing process in FIG. 28 structures the second side of the base portion to include the base contour to contact the surface of a patient's tooth. The additive manufacturing process also forms the base portion to include torque angle based on the design of the base portion at 101. The process in FIG. 28 also includes providing a bracket portion 400 including a body comprising a first side, a second side, and an archwire slot formed into the first side. In some forms, providing a bracket portion can comprise selecting the bracket portion from a group of different bracket portions based on one or more of an orthodontic prescription for the patient's tooth to which the bracket assembly including the bracket portion is to be attached, a material of construction of the bracket portion, and a process by which the bracket portion was made. The process in FIG. 28 also includes affixing the second side of the bracket portion to the first side of the base portion 400. An orthodontic bracket assembly produced by the process in FIG. 28 includes an orthodontic prescription for the patient's tooth to which the bracket assembly is configured to be attached and the orthodontic prescription comprises a torque angle.

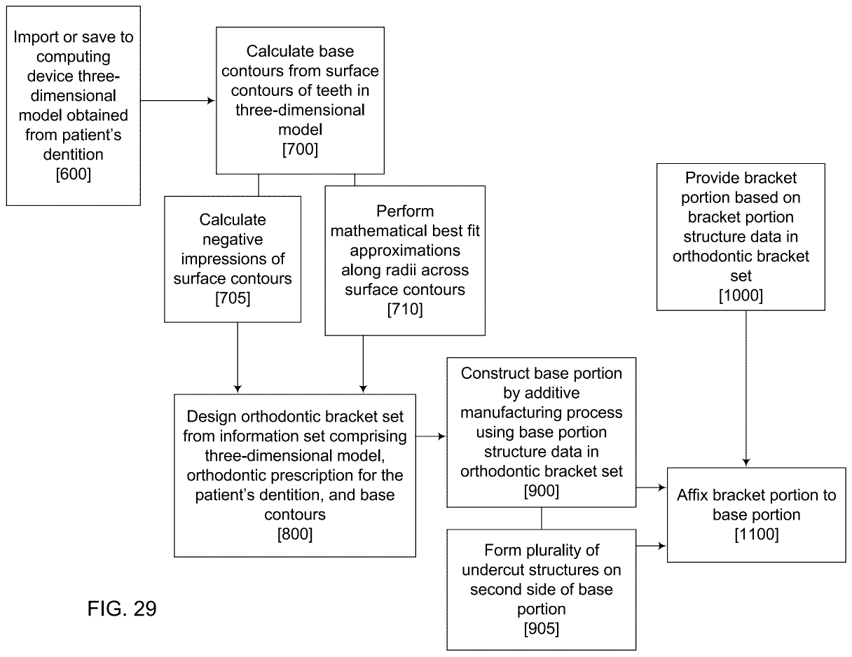

FIG. 29 illustrates an embodiment of a process of manufacturing orthodontic bracket assemblies, which includes importing or saving to a computing device a three-dimensional model obtained from a patient's dentition 600. The process in FIG. 29 also includes calculating base contours from surface contours of a plurality of teeth depicted in the three-dimensional model 700. In some forms, calculating the base contours can comprise calculating negative impressions of surface contours of the plurality of the patient's teeth depicted in the three-dimensional model 705. In some aspects, calculating the base contours can comprise performing mathematical best fit approximations along a radius oriented in a first direction and a radius oriented in a second direction across the surface contours of each of the patient's teeth depicted in the three-dimensional model 710, where the radius oriented in the first direction intersects the radius oriented in the second direction. The process in FIG. 29 also includes designing an orthodontic bracket set from an information set comprising the three-dimensional model, an orthodontic prescription for the patient's dentition, and the base contours 800. The designed orthodontic bracket set includes a plurality of bracket assembly models corresponding to the plurality of teeth such that each bracket assembly model comprises bracket portion structure data and base portion structure data. Base portion structure data can include the calculated base contour corresponding to a specific tooth. The process in FIG. 29 also includes constructing a base portion by an additive manufacturing process using base portion structure data 900. The constructed base portion comprises a first side and a second side with the second side comprising the base contour structured to receive the surface contour of the specific tooth. In some aspects, constructing the base portion by the additive manufacturing process can further comprise forming a plurality of undercut structures on the second side of the base portion 905. The process in FIG. 29 also includes providing a bracket portion based on bracket portion structure data 1000. The bracket portion includes a body comprising a first side, a second side, and an archwire slot formed on the first side of the body. In some forms, providing a bracket portion can comprise selecting the bracket portion from a group of different bracket portions based on the bracket portion structure data and an orthodontic prescription for the patient's tooth to which the bracket assembly including the bracket portion is to be attached. In some aspects, a bracket portion can further be selected based on one or more of a material of construction of the bracket portion and a process by which the bracket portion was made. The process in FIG. 29 also includes affixing the bracket portion to the base portion 1100 with the first side of the bracket portion facing away from the first side of the base portion.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

1. An orthodontic bracket assembly comprising:
a bracket portion including a body comprising a first side and a second side, and an archwire slot formed on the first side of the body; and
a base portion having been constructed separately from the bracket portion by additive manufacturing, the base portion comprising a first side and a second side, the second side comprising a base contour configured to contact a surface of a patient's tooth, the bracket portion being affixed to the base portion with the first side of the bracket portion facing away from the first side of the base portion,
an orthodontic prescription for the patient's tooth being incorporated into the orthodontic bracket assembly, the orthodontic prescription comprising a torque angle, at least a portion of the torque angle being incorporated into the bracket portion or the base portion.

2. The orthodontic bracket assembly according to claim 1, wherein the torque angle is incorporated into the bracket portion and the base portion

3. The orthodontic bracket assembly according to claim 1, wherein the orthodontic prescription further comprises an offset angle, and at least a portion of the offset angle is incorporated in the bracket portion or the base portion.

4. The orthodontic bracket assembly according to claim 1, wherein the orthodontic prescription further comprises a tip angle, and at least a portion of the tip angle is incorporated in the bracket portion or the base portion.

5. The orthodontic bracket assembly according to claim 1, wherein the torque angle is configured to exist between an occlusal plane formed by the patient's tooth and a line normal to a floor of the archwire slot and bisecting the archwire slot, when viewing along an axis of the archwire slot at a cross-section of the bracket assembly taken along an occlusal-gingival direction and through a centroid of the second side of the base portion upon affixing the second side of the base portion to the patient's tooth.

6. The orthodontic bracket assembly according to claim 3, wherein at a cross-section of the bracket assembly along a mesial-distal direction through a centroid of the second side of the base portion and viewed from an occlusal side, the offset angle exists between a first line along a floor of the archwire slot and a second line, the second line intersects a third line at the centroid of the second side of the base portion, the second line is orthogonal to the third line, and at the centroid of the second side of the base portion the third line is normal at least both a mathematical best fit curve of the base contour along a first direction across the base contour and a mathematical best fit curve of the base contour along a second direction across the base contour, wherein the first direction is different from the second direction.

7. The orthodontic bracket assembly according to claim 4, wherein the tip angle is configured to exist between a crown long axis of the patient's tooth and a line both orthogonal to an axis of the archwire slot and parallel to a floor of the archwire slot, upon affixing the second side of the base portion to the patient's tooth.

8. The orthodontic bracket assembly according to claim 1, wherein at a cross-section of the bracket assembly along an occlusal-gingival direction through a centroid of a second side of a base portion and viewed along an axis of an archwire slot, an in-out distance of the bracket assembly is a length of a line having an endpoint at a center point of a floor of the archwire slot and an endpoint at the centroid on the second side of the base portion, the center point of the floor of the archwire slot being equidistant from opposing walls of the archwire slot.

9. The orthodontic bracket assembly according to claim 1, wherein the archwire slot comprises a floor and opposing walls providing the archwire slot with a rectangular cross-section.

10. The orthodontic bracket assembly according to claim 1, wherein the base contour is structured to receive a surface contour of the patient's tooth depicted in a three-dimensional model of the patient's dentition.

11. The orthodontic bracket assembly according to claim 10, wherein structure of the base contour has been calculated as a negative impression of the surface contour of the patient's tooth depicted in the three-dimensional model.

12. The orthodontic bracket assembly according to claim 10, wherein structure of the base contour has been calculated by a process comprising performing mathematical best fit approximations along a radius oriented in a first direction across a surface contour of a tooth depicted in a three-dimensional model and a radius oriented in a second direction across the surface contour, where the radius oriented in the first direction intersects the radius oriented in the second direction.

13. (canceled)

14. (canceled)

15. (canceled)

16. An orthodontic bracket assembly comprising:
a bracket portion including a body comprising a first side and a second side, an archwire slot formed in the body, and
a base portion having been constructed separately from the bracket portion by additive manufacturing, the base portion comprising a first side and a second side, the bracket portion being affixed to the base portion with the first side of the bracket portion facing away from the first side of the base portion, and the second side of the base portion comprising a base contour configured to contact a surface of a patient's tooth,
an orthodontic prescription for the patient's tooth incorporated into the orthodontic bracket assembly, the orthodontic prescription comprising a torque angle, at least a portion of the torque angle being incorporated into the bracket portion or the base portion,
wherein at a cross-section of the bracket assembly along an occlusal-gingival direction through a centroid of the second side of the base portion and viewed along an axis of the archwire slot:
any torque angle incorporated in the bracket portion is measured between first line and a fourth line, the first line being along floor of the archwire slot, the fourth line being within a plane resting on at least three points of a facial-most surface of the first side of the body of the bracket portion, and
any torque angle incorporated in the base portion is measured between a second line and the fourth line, the second line both intersecting and orthogonal to a third line at the centroid of the second side of the base portion, at the centroid of the second side of the base portion the third line being normal to at least both a mathematical best fit curve of the base contour along a first direction across the base contour and a mathematical best fit curve of the base contour along a second direction across the base contour, wherein the first direction is different from the second direction.

17. The orthodontic bracket assembly according to claim 16, wherein no torque angle is incorporated in the bracket portion.

18. The orthodontic bracket assembly according to claim 16, wherein no torque angle is incorporated in the base portion.

19. The orthodontic bracket assembly according to claim 16, wherein the orthodontic prescription further comprises an offset angle,
at a cross-section of the bracket assembly along a mesial-distal direction through a centroid of the second side of the base portion and viewed from an occlusal side, offset angle being between a first line along or parallel to a floor of an archwire slot and a second line, the second line intersecting and orthogonal to a third line at the centroid of the second side of the base portion, at the centroid of the second side of the base portion the third line being normal to at least both a mathematical best fit curve of the base contour along a first direction across the base contour and a mathematical best fit curve of the base contour along a second direction across the base contour, wherein the first direction is different from the second direction.

20. The orthodontic bracket assembly according to claim 19, wherein at least a portion of the offset angle is incorporated in the bracket portion or the base portion,
any offset angle incorporated in the base portion is measured between the second line and a fourth line, the fourth line existing within a plane resting on at least three points of a facial-most surface of the first side of the body of the bracket portion, and
any offset angle incorporated in the bracket portion is measured between the first line and the fourth line.

21. The orthodontic bracket assembly according to claim 16, wherein the orthodontic prescription further comprises a tip angle between a line both orthogonal to an axis of the archwire slot and parallel to the floor of the archwire slot and a crown long axis of the patient's tooth to which the bracket assembly is configured to be attached, when viewing a facial aspect of the patient's tooth.

22. The orthodontic assembly according to claim 16, wherein the orthodontic prescription further comprises a tip angle, and at least a portion of the tip angle is incorporated in the base portion or the bracket portion,
any tip angle incorporated into the base portion is measured between first line along a mesial edge or distal edge of the base portion and second line both orthogonal to an axis of the archwire slot and parallel to a floor of the archwire slot, when viewing a facial aspect, and
any tip angle incorporated into a bracket portion is measured between a third line formed along a mesial or distal edge of a base of a bracket portion and the second line, when viewing a facial aspect.

23. A process of manufacturing an orthodontic bracket assembly, the process comprising:
forming a base portion by an additive manufacturing process, the base portion comprising a first side and a second side, the additive manufacturing process structuring the second side of the base portion to contact a surface of a patient's tooth;
providing a bracket portion including a body comprising a first side, a second side, and an archwire slot formed into the first side, and
affixing the second side of the bracket portion to the first side of the base portion,
the orthodontic bracket assembly including an orthodontic prescription for the patient's tooth to which the bracket assembly is configured to be attached, the orthodontic prescription comprising a torque angle.

24. The process according to claim 23, wherein the torque angle exists between an occlusal plane formed by the patient's tooth and a line normal to a floor of the archwire slot and bisecting the archwire slot, when viewing along an axis of the archwire slot at a cross-section of the bracket assembly taken along an occlusal-gingival direction through a centroid of a second side of a base portion upon affixing the second side of the base portion to the patient's tooth.

25. The process according to claim 23, further comprising:
importing or saving to a computing device a three-dimensional model obtained from a patient's dentition;
calculating a base contour from a surface contour of the patient's tooth depicted in the three-dimensional model; and
through the additive manufacturing process, forming the second side of the base portion to comprise the base contour.

26. The process according to claim 25, wherein calculating the base contour comprises calculating a negative impression of the surface contour of the patient's tooth depicted in the three-dimensional model.

27. The process according to claim 25, wherein calculating the base contour comprises performing mathematical best fit approximations along a radius oriented in a first direction across a surface contour of a tooth depicted in a three-dimensional model and radius oriented in a second direction across the surface contour, where the radius oriented in the first direction intersects the radius oriented in the second direction.

28. The process according to claim 23, further comprising:
importing or saving the orthodontic prescription to a computing device; and
designing the base portion using the computing device to comprise the torque angle.
